(19) United States
(12) Patent Application Publication
(10) Pub. No.: US 2005/0254364 A1
(43) Pub. Date: Nov. 17, 2005

(54) Information generation device, information reproduction device, and information recording device

(76) Inventor: Kazuo Kuroda, Saitama (JP)

Correspondence Address: MORGAN LEWIS & BOCKIUS LLP, 1111 PENNSYLVANIA AVENUE NW, WASHINGTON, DC, 20004, US

(21) Appl. No.: 10/525,641

(22) PCT Filed: Aug. 29, 2003
(86) PCT No.: PCT/JP03/11055

§ 371 Date: Feb. 25, 2005

(30) Foreign Application Priority Data
Aug. 30, 2002 (JP) 2002-254796

(51) Int. Cl. G11B 5/09

(52) U.S. Cl. 369/47.1; 369/47.12; 369/53.1

(57) ABSTRACT

An information distribution system is provided which can distribute a movie and so on while restricting the copying of information more widely and properly in the case where the information such as a movie is distributed via a network and so on.

Change copy control information (XCI1, XCI2, XXI1, and XXI2) and normal copy control information (CCI1 and CCI2) are superimposed on reproduced information and are distributed. The change copy control information is used when a changing operation for changing the quality of reproduced information is performed, and the normal copy control information is used when the changing operation is not performed.

### TECHNICAL FIELD

The present application relates to a technical field including an information generating apparatus, an information reproducing apparatus, and an information recording apparatus and specifically relates to a technical field including an information generating apparatus for generating information to be distributed or delivered via airwaves or a recording medium such as an optical disc, an information reproducing apparatus for reproducing the distributed or delivered information, and an information recording apparatus for recording the distributed or delivered information on another recording medium.

### BACKGROUND ART

In recent years, so-called DVDs (Digital Versatile Discs) have become widespread which are several times larger in recording capacity than conventional CDs (Compact Discs). Since the DVD has such a large recording capacity, moving image information of one movie and the corresponding sound information can be recorded on the DVD.

Movies and so on which can be recorded on the DVD are generally protected by so-called copyright. To be specific, for example, the permissible number of stages of copying on other recording media (that is, for example, a movie and so on are legally copied and recorded from a playback only DVD to a recordable DVD, and are copied and recorded repeatedly from the DVD where the movie and so on have been copied and recorded once) is determined beforehand in many cases. A player or the like for reproducing the movie and so on from the DVD is configured so that the movie and so on cannot be reproduced from the DVD when the number of times of copying exceeds the predetermined number of copying/recording stages.

A specific solution for preventing copying/recording in more than the predetermined number of stages is described below. For example, in the case of a movie and so on which can be legally copied and recorded only once from a playback only DVD, copy control information (may be generally referred to as CCI information), which indicates that copying can be performed only once, is protected against tampering (e.g., so-called watermarking) in a specific manner and is recorded on the playback only DVD with recording information corresponding to the movie and so on. When the movie and soon are legally copied and recorded, the contents of originally recorded copy control information are changed from “copy permitted only once (One More Copy)” to “copy and recording prohibited (No More Copy)” along with copying and recording. Hence, even if the movie and so on having been copied and recorded once are copied and recorded in stages again, since the contents of copy control information recorded on the DVD with the movie and so on indicates “copy prohibited”, reproduction for copying and recording the recording information from the DVD becomes impossible, thereby preventing illegal copying and recording.

Regarding copy control information recorded on conventional DVDs, one kind of movie and so on generally have only one kind of copy control information. No matter whether the movie and so on are reproduced with degraded picture quality or maintained picture quality during reproduction, only one restrictive condition of copying is always applied to one kind of movie and so on.

As a channel for distributing movies and so on to viewers, a channel for distribution in an electronic manner via a network such as the Internet has been developed in recent years in addition to a conventional method of selling or lending playback only DVDs to the viewers. When movies and so on are delivered (distributed) via the network, various kinds of picture quality conversion are generally performed on a distribution channel. Thus, it has become taken for granted that one movie is distributed with two or more kinds of picture quality (or sound quality, hereinafter referred to as picture quality and so on).

In spite of the fact that movies and so on are distributed with kinds of picture quality via various channels, only one restrictive condition of copying is always applied to one kind of movie and so on in order to prevent illegal copying. Consequently, no matter whether the movie and so on are distributed with high picture quality or low picture quality, the distribution has to be made under the same restrictive condition of copying.

Due to this problem, the following distribution pattern cannot be obtained: for example, when a movie and so on are distributed with low picture quality, free copying is permitted to make the movie and so on widely available to viewers, and when the movie and so on are generally recognized, the same movie and so on are distributed with high picture quality while a copying restriction is imposed. Consequently, the movie and so on cannot be effectively distributed.

### DISCLOSURE OF THE INVENTION

The present application is devised in view of the problem. An example of an object is to provide an information generating apparatus for distributing a movie and so on while widely and properly restricting the copying of information when distributing the information such as a movie via a network and so on, an information reproducing apparatus for reproducing the recorded information, and an information recording apparatus for recording the distributed information on a recording medium.

In order to attain the example of the object, a first invention provides an information generating apparatus comprising adding means for adding change copy control information and normal copy control information to an information signal, the change copy control information being used when a changing operation for changing the quality of the information signal is performed, the normal copy control information being used when the changing operation is not performed.

According to the first invention, the change copy control information and the normal copy control information are added to the information signal. Thus, it is possible to change the contents of the subsequent copying restriction according to the presence or absence of a change in quality and so on when the information signal is demodulated or recorded, thereby effectively protecting the copyright of the information signal.

Another preferred embodiment of the first invention is characterized in that the changing operation is quality degradation for degrading the quality of the information signal.

According to this embodiment, since the changing operation is quality degradation for degrading the quality of the information signal, it is possible to change the contents of the subsequent copying restriction according to the presence or absence of degradation of quality and so on during the demodulation or recording of the information signal, thereby effectively protecting the copyright of the information signal.

Still another preferred embodiment of the first invention is characterized in that the information signal includes at least image information, and the changing operation is enlargement for scaling up an image corresponding to the image information or a reduction for scaling down the image.

According to this embodiment, the information signal includes at least image information and the changing operation is enlargement for scaling up an image corresponding to the image information or a reduction for scaling down the image. Thus, it is possible to change the contents of the subsequent copying restriction according to the presence or absence of enlargement or a reduction the image during the demodulation or recording of the information signal including the image information, thereby effectively protecting the copyright of the image information.

Further, a preferred embodiment of the first invention is characterized in that the changing operation is enlargement for scaling up an image corresponding to the image information or a reduction for scaling down the image and superimposition of another image information on the image information having been subjected to enlargement or a reduction.

According to this embodiment, the changing operation is enlargement for scaling up an image corresponding to the image information or a reduction for scaling down the image and superimposition of another image information on the image information having been subjected to enlargement or a reduction. Thus, it is possible to change the contents of the subsequent copying restriction according to the presence or absence of enlargement or a reduction of the image and superimposition of another image during the demodulation or recording of the information signal including the image information, thereby effectively protecting the copyright of the image information.

Another preferred embodiment of the present invention is characterized in that the changing operation is superimposition of advertisement information on the information signal.

According to this embodiment, since the changing operation is superimposition of advertisement information on the information signal, it is possible to change the contents of the subsequent copying restriction according to the presence or absence of superimposition of advertisement information during the demodulation or recording of the information signal, thereby effectively protecting the copyright of the image information.

Still another embodiment of the first invention is characterized in that the changing operation is a reducing operation for reducing an amount of data of the information signal.

According to this operation, since the changing operation is a reducing operation for reducing an amount of data of the information signal, it is possible to change the contents of the subsequent copying restriction according to the presence or absence of the reducing operation during the demodulation or recording of the information signal, thereby effectively protecting the copyright of the image information.

Further, a preferred embodiment of the first invention is characterized in that the change copy control information includes restrictive conditions for copying, the conditions being more moderate than restrictive conditions for copying of the normal copy control information.

According to this embodiment, the change copy control information includes restrictive conditions for copying, the conditions being more moderate than restrictive conditions for copying of the normal copy control information. Thus, it is possible to make moderate the contents of the subsequent copying restriction according to the presence or absence of a change in quality and so on during the demodulation or recording of the information signal, thereby effectively protecting the copyright of the information signal.

Another preferred embodiment of the first invention is characterized in that the adding means embeds the change copy control information and the normal copy control information in the information signal by using digital watermarking.

According to this embodiment, the change copy control information and the normal copy control information are embedded in the information signal by using digital watermarking. Thus, it is possible to make difficult illegal acquisition of the change copy control information and the normal copy control information, thereby effectively protecting the copyright of the information signal.

In order to attain the example of the object, a second invention provides an information reproducing apparatus for reproducing an information signal, to which change copy control information and normal copy control information are added, the change copy control information being used when a changing operation for changing quality of the information signal is performed, the normal copy control information being used when the changing operation is not performed, the apparatus comprising: changing means for performing the changing operation, and setting means for, when the changing operation is performed and the information signal is reproduced, setting copy control information included in the reproduced information signal, the information being set as the contents of the change copy control information at a value indicated the change copy control information.

According to the second invention, when the changing operation is performed on the information signal, to which change copy control information and normal copy control information are added, and the information signal is outputted, the copy control information included in the reproduced information signal is set at a value indicated the change copy control information. Thus, regarding the changed information signal, it is possible to effectively protect the copyright of the information signal.

A preferred embodiment of the second invention is characterized in that when the information signal is reproduced without the changing operation, the setting means sets, as the contents of the normal copy control information, the contents of the copy control information included in the reproduced information signal.

According to this embodiment, when the information signal is reproduced without the changing operation, the contents of the copy control information included in the reproduced information signal are set as the contents of the normal copy control information. Regarding the information signal not being changed, it is possible to effectively protect the copyright of the information signal.

In order to attain the example of the object, a third invention provides an information reproducing apparatus for reproducing an information signal added with change information indicating whether a changing operation for changing quality of the information signal is performed or not, change copy control information being used when the changing operation is performed and normal copy control information being used when the changing operation is not performed, the reproducing apparatus, comprising: detecting means for detecting the change information, deciding means for deciding whether the quality is changed or not according to the detected change information, and setting means for setting, when the quality is changed, the contents of copy control information included in the reproduced information signal at a value indicated the change copy control information.

According to the third invention, when the information signal added with change information, change copy control information and normal copy control information is changed and reproduced, the contents of the copy control information included in the reproduced information signal are set at a value indicated the change copy control information. Thus, regarding the changed information signal, it is possible to effectively protect the copyright of the information signal.

In order to attain the example of the object, a fourth invention provides an information recording apparatus for recording an information signal, to which change copy control information and normal copy control information are added, the change copy control information being used when a changing operation for changing quality of the information signal is performed, the normal copy control information being used when the changing operation is not performed, on an information recording medium, the recording apparatus, comprising: changing means for performing the changing operation, selecting means for selecting a kind of the changing operation capable of recording the information signal on the recording medium, and recording means for recording the information signal on the recording medium, the information signal having been changed in quality by the selected changing operation.

According to the fourth invention, a kind of the changing operation capable of recording the information signal, to which change copy control information and normal copy control information are added, is selected and the information signal having been changed in quality by the selected changing operation is recorded on the recording medium. Thus, it is possible to effectively protect the copyright of the information signal.

In order to attain the example of the object, a fifth invention provides an information recording apparatus for recording an information signal, to which change copy control information and normal copy control information are added, the change copy control information being used when a changing operation for changing quality of the information signal is performed, the normal copy control information being used when the changing operation is not performed, on a recording medium, the recording apparatus, comprising: changing means for performing the changing operation, first recording means for recording the information signal changed in quality on the recording medium, and second recording means for recording change information on the recording medium, the change information indicating that the quality of the information signal is changed.

According to the fifth invention, the change information can be recorded on the recording medium with the changed information signal. Thus, during the reproduction of the recording medium, it is decided whether the quality is changed or not according to the contents of the change information, and it is possible to set copy control information included in the reproduced information signal, based on the decision result, at a value indicated the change copy control information, thereby effectively protecting the copyright of the information signal changed in quality.

In order to attain the example of the object, a sixth invention provides an information generating method comprising an adding step of adding change copy control information and normal copy control information to the information signal, the change copy control information being used when a changing operation for changing the quality of the information signal is performed, the normal copy control information being used when the changing operation is not performed.

According to the sixth invention, the change copy control information and the normal copy control information are added to the information signal. Thus, it is possible to change the contents of the subsequent copying restriction according to the presence or absence of a change in quality and so on when the information signal is demodulated or recorded, thereby effectively protecting the copyright of the information signal.

In order to attain the example of the object, a seventh invention provides an information reproducing method for reproducing an information signal, to which change copy control information and normal copy control information are added, the change copy control information being used when a changing operation for changing quality of the information signal is performed, the normal copy control information being used when the changing operation is not performed, the method comprising: a changing step of performing the changing operation, and a setting step of, when the changing operation is performed and the information signal is reproduced, setting copy control information included in the reproduced information signal at a value indicated the change copy control information.

According to the seventh invention, when the changing operation is performed on the information signal, to which change copy control information and normal copy control information are added, and the information signal is outputted, the copy control information included in the reproduced information signal is set at a value indicated the change copy control information. Thus, regarding the changed information signal, it is possible to effectively protect the copyright of the information signal.

In order to attain the example of the object, an eighth invention provides an information reproducing method for reproducing an information signal added with change information indicating whether a changing operation for changing quality of the information signal is performed or not, change copy control information being used when the changing operation is performed and normal copy control information being used when the changing operation is not performed, the reproducing method, comprising: a detecting step of detecting the change information, a deciding step of deciding whether the quality is changed or not according to the detected change information, and a setting step of setting, when the quality is changed, the contents of copy control information included in the reproduced information signal at a value indicated the change copy control information.

According to the eighth invention, when the information signal added with change information, change copy control information and normal copy control information, is changed and reproduced, the contents of the copy control information included in the reproduced information signal are set at a value indicated the change copy control information. Thus, regarding the changed information signal, it is possible to effectively protect the copyright of the information signal.

In order to attain the example of the object, a ninth invention provides an information recording method for recording an information signal, to which change copy control information and normal copy control information are added, the change copy control information being used when a changing operation for changing quality of the information signal is performed, the normal copy control information being used when the changing operation is not performed, on an information recording medium, the recording method, comprising: a changing step of performing the changing operation, a selecting step of selecting a kind of the changing operation capable of recording the information signal on the recording medium, and a recording step of recording the information signal on the recording medium, the information signal having been changed in quality by the selected changing operation.

According to the ninth invention, a kind of the changing operation capable of recording the information signal, to which change copy control information and normal copy control information are added, is selected and the information signal having been changed in quality by the selected changing operation is recorded on the recording medium. Thus, it is possible to effectively protect the copyright of the information signal.

In order to attain the example of the object, a tenth invention provides an information recording method for recording an information signal, to which change copy control information and normal copy control information are added, the change copy control information being used when a changing operation for changing quality of the information signal is performed, the normal copy control information being used when the changing operation is not performed, on a recording medium, the recording method, comprising: a changing step of performing the changing operation, a first recording step of recording the information signal changed in quality on the recording medium, and a second recording step of recording change information on the recording medium, the change information indicating that the quality of the information signal is changed.

According to the tenth invention, the change information can be recorded on the recording medium with the changed information signal. Thus, during the reproduction of the recording medium, it is decided whether the quality is changed or not according to the contents of the change information, and it is possible to set copy control information included in the reproduced information signal, based on the decision result, at a value indicated the change copy control information, thereby effectively protecting the copyright of the information signal changed in quality.

In order to attain the example of the object, an eleventh invention provides a copyright protecting method for protecting the copyright of an information signal by adding, to the information signal, copy control information for restricting the copying of the information signal, the copy control information including change copy control information being used when a changing operation for changing quality of the information signal is performed and normal copy control information being used when the changing operation is not performed.

According to the eleventh invention, the change copy control information being used when a changing operation for changing quality of the information signal is performed and the normal copy control information being used when the changing operation is not performed are included which corresponds to the quality of the information signal. Thus, regarding two or more kinds of information signal with different qualities, it is possible to effectively protect the copyright of each information signal.

In order to attain the example of the object, a twelfth invention provides an information generating program for causing a generating computer included in an information generating apparatus to act as adding means for adding change copy control information and normal copy control information to an information signal, the change copy control information being used when a changing operation for changing the quality of the information signal is performed, the normal copy control information being used when the changing operation is not performed.

According to the twelfth invention, the generating computer operates to add the change copy control information and the normal copy control information to the information signal. Thus, it is possible to change the contents of the subsequent copying restriction according to the presence of absence of a change in quality and soon when the information signal is demodulated or recorded, thereby effectively protecting the copyright of the information signal.

In order to attain the example of the object, a thirteenth invention provides an information reproducing program for causing a reproducing computer included in an information reproducing apparatus for reproducing an information signal, to which change copy control information and normal copy control information are added, the change copy control information being used when a changing operation for changing quality of the information signal is performed, the normal copy control information being used when the changing operation is not performed, to act as changing means for performing the changing operation, and setting means for, when the changing operation is performed and the information signal is reproduced, setting copy control information included in the reproduced information signal at a value indicated the change copy control information.

According to the thirteenth invention, when the changing operation is performed on the information signal, to which change copy control information and normal copy control information are added, and the information signal is outputted, the reproducing computer operates to set the copy control information included in the reproduced information signal at a value indicated the change copy control information. Thus, regarding the changed information signal, it is possible to effectively protect the copyright of the information signal.

In order to attain the example of the object, a fourteenth invention provides an information reproducing program for a reproducing computer included in an information reproducing apparatus for reproducing an information signal added with change information indicating whether a changing operation for changing is performed or not, change copy control information being used when the changing operation is performed and normal copy control information being used when the changing operation is not performed, the reproducing program causing the reproducing apparatus to act as: detecting means for detecting the change information, deciding means for deciding whether the quality is changed or not according to the detected change information, and setting means for setting, when the quality is changed, copy control information included in the reproduced information signal at a value indicated the change copy control information.

According to the fourteenth invention, when the information signal added with change information, change copy control information and normal copy control information, is changed and reproduced, the reproducing computer operates to set the copy control information included in the reproduced information signal at a value indicated the change copy control information. Thus, regarding the changed information signal, it is possible to effectively protect the copyright of the information signal.

In order to attain the example of the object, a fifteenth invention provides an information recording program for a recording computer included in an information recording apparatus for recording an information signal, to which change copy control information and normal copy control information are added, the change copy control information being used when a changing operation for changing quality of the information signal is performed, the normal copy control information being used when the changing operation is not performed, on an information recording medium, the recording program causing the recording computer to act as: changing means for performing the changing operation, selecting means for selecting a kind of the changing operation capable of recording the information signal on the recording medium, and recording means for recording the information signal on the recording medium, the information signal having been changed in quality by the selected changing operation.

According to the fifteenth invention, the recording computer operates so that a kind of the changing operation capable of recording the information signal, to which change copy control information and normal copy control information are added, is selected and the information signal having been changed in quality is recorded by the selected changing operation on the recording medium. Thus, it is possible to effectively protect the copyright of the information signal.

In order to attain the example of the object, a sixteenth invention provides an information recording program for a recording computer included in an information recording apparatus for recording an information signal, to which change copy control information and normal copy control information are added, the change copy control information being used when a changing operation for changing quality of the information signal is performed, the normal copy control information being used when the changing operation is not performed, on a recording medium, the recording program causing the recording computer to act as: changing means for performing the changing operation, first recording means for recording the information signal changed in quality on the recording medium, and second recording means for recording change information on the recording medium, the change information indicating that the quality of the information signal is changed.

According to the sixteenth invention, the recording computer operates so that the change information can be recorded on the recording medium with the changed information signal. Thus, during the reproduction of the recording medium, it is decided whether the quality is changed or not according to the contents of the change information, and it is possible to set copy control information included in the reproduced information signal, based on the decision result, at a value indicated the change copy control information, thereby effectively protecting the copyright of the information signal changed in quality.

In order to attain the example of the object, a seventeenth invention provides an information recording medium where the information generating program of the twelfth invention is recorded so that the program is read by the generating computer.

According to the seventeenth invention, since the information generating program is read and executed by the generating computer, the generating computer so operates as to add the change copy control information and the normal copy control information to the information signal. Thus, it is possible to change the contents of the subsequent copying restriction according to the presence or absence of a change in quality and so on when the information signal is demodulated or recorded, thereby effectively protecting the copyright of the information signal.

In order to attain the example of the object, an eighteenth invention provides an information recording medium where the information reproducing program of the thirteenth or fourteenth invention is recorded so that the program is read by the reproducing computer.

According to the eighteenth invention, when the information reproducing program of the thirteenth invention is recorded, the information reproducing program is read and executed by the reproducing computer and thus when the information signal is changed and reproduced, the reproducing computer operates so that the copy control information included in the reproduced information signal is set at a value used when the changing operation is performed, thereby effectively protecting the copyright of the changed information signal.

Further, when the information reproducing program of the fourteenth invention is recorded, the information reproducing program is read and executed by the reproducing computer and thus when the information signal is changed and reproduced, the reproducing computer operates so that the copy control information included in the reproduced information signal is set at a value used when the changing operation is performed, thereby effectively protecting the copyright of the changed information signal.

In order to attain the example of the object, a nineteenth invention provides an information recording medium where the information reproducing program of the fifteenth or sixteenth invention is recorded so that the program is read by the recording computer.

According to the nineteenth invention, when the information recording program of the fifteenth invention is recorded, the information recording program is read and executed by the recording computer. Thus, the recording computer operates so that a kind of the changing operation capable of recording an information signal is selected and the information signal changed in quality by the selected changing operation is recorded on the recording medium, thereby effectively protecting the copyright of the information signal.

Further, when the information recording program of the sixteenth invention is recorded, the information recording program is read and executed by the reproducing computer and thus the recording computer operates so that the change information is recorded on the recording medium with the changed information signal. Thus, during the reproduction of the recording medium, it is decided whether the quality is changed or not according to the contents of the change information. When the quality is changed, it is possible to set copy control information included in the reproduced information signal at a value used when the contents of the copy control information are changed, thereby effectively protecting the copyright of the information signal changed in quality.

In order to attain the example of the object, a twentieth invention provides a recording medium comprising an information recording area for recording an information signal added with change copy control information used when a changing operation for changing the quality of the information signal is performed and normal copy control information used when the changing operation is not performed.

According to the twentieth invention, the information signal is recorded which is added with the change copy control information and the normal copy control information. Thus, it is possible to change the contents of the subsequent copying restriction according to the presence or absence of a change in quality and so on when the information signal is demodulated or recorded, thereby effectively protecting the copyright of the information signal.

In order to attain the example of the object, a twenty first invention provides a recording medium comprising an information recording area for recording an information signal added with change information indicating whether the quality of the information signal is changed or not.

According to the twenty first invention, the change information is recorded on the recording medium. Thus, during the reproduction of the recording medium, it is decided whether the quality is changed or not according to the contents of the change information. When the quality is changed, it is possible to set copy control information included in the reproduced information signal at a value used when the contents of the copy control information are changed, thereby effectively protecting the copyright of the information signal changed in quality.

### BRIEF DESCRIPTION OF THE DRAWINGS

FIG. 1 is a diagram showing a recording format of information on a DVD according to Embodiment 1;

FIG. 2 is a diagram (I) showing the specific contents of information recorded on the DVD of Embodiment 1;

FIG. 2(a) is a diagram showing the specific contents of a first information table;

FIG. 2(b) is a chart showing a comparison of the contents of copy control information before and after conversion;

FIG. 2(c) is a diagram showing the specific contents of a second information table;

FIG. 3 is a diagram (II) showing the specific contents of information recorded on the DVD of Embodiment 1;

FIG. 3(a) is a diagram (I) showing the specific contents of copy control information;

FIG. 3(b) is a diagram (II) showing the specific contents of copy control information;

FIG. 4 is a diagram (III) showing the specific contents of information recorded on the DVD of Embodiment 1;

FIG. 4 (a) is a diagram (I) showing the specific contents of post conversion copy control information;

FIG. 4(b) is a diagram (II) showing the specific contents of post conversion copy control information;

FIG. 4(c) is a diagram (III) showing the specific contents of post conversion copy control information;

FIG. 4(d) is a diagram (IV) showing the specific contents of post conversion copy control information;

FIG. 5 is a block diagram showing the schematic configuration of an information reproducing apparatus according to Embodiment 1;

FIG. 6 is a flowchart showing reproduction performed in the information reproducing apparatus according to Embodiment 1;

FIG. 7 is a block diagram showing the schematic configuration of an information transmission system according to Embodiment 2;

FIG. 8 is a block diagram showing the schematic configuration of a video transmitter according to Embodiment 2;

FIG. 9 is a diagram showing a format of recording information transmitted in the information transmission system of Embodiment 2;

FIG. 10 is a diagram showing the specific contents of recording information according to Embodiment 2;

FIG. 10(a) is a diagram (I) showing specific contents;

FIG. 10(b) is a diagram (II) showing specific contents;

FIG. 11 is a block diagram showing the schematic configuration of a set-top box according to Embodiment 2;

FIG. 12 is a flowchart showing a receiving operation according to Embodiment 2;

FIG. 13 is a block diagram showing the schematic configuration of a recorder according to Embodiment 2;

FIG. 14 is a flowchart showing a recording operation according to Embodiment 2;

FIG. 15 is a diagram showing the specific contents of recording information according to Embodiment 3;

FIG. 15(a) is a diagram (I) showing the specific contents of a sub information table;

FIG. 15(b) is a diagram (II) showing the specific contents of a sub information table;

FIG. 16 is a flowchart showing information reproduction according to Embodiment 4;

FIG. 17 is a diagram showing the specific contents of information recorded on a DVD according to Embodiment 5;

FIG. 18 is a block diagram showing the schematic configuration of a recorder according to Embodiment 5;

FIG. 19 is a flowchart showing a recording operation in the recorder according to Embodiment 5;

FIG. 20 is a flowchart showing a recording operation in a recorder according to Embodiment 6;

FIG. 21 is a flowchart showing reproduction in a DVD player according to Embodiment 6; and

FIG. 22 is a flowchart showing reproduction in a DVD player according to Embodiment 7.

### BEST MODE FOR CARRYING OUT THE INVENTION

Preferred embodiments of the present invention will be described below in accordance with the accompanying drawings.

In the embodiments below, the present invention is applied to an information transmission system for distributing or delivering information which is subjected to conversion, in which picture quality and so on are changed (degraded) during reproduction performed by an information reproducing apparatus and so on at the destination. The information includes a movie which is recorded on a DVD and distributed, or delivered via airwaves or a network such as the Internet.

### (I) Embodiment 1

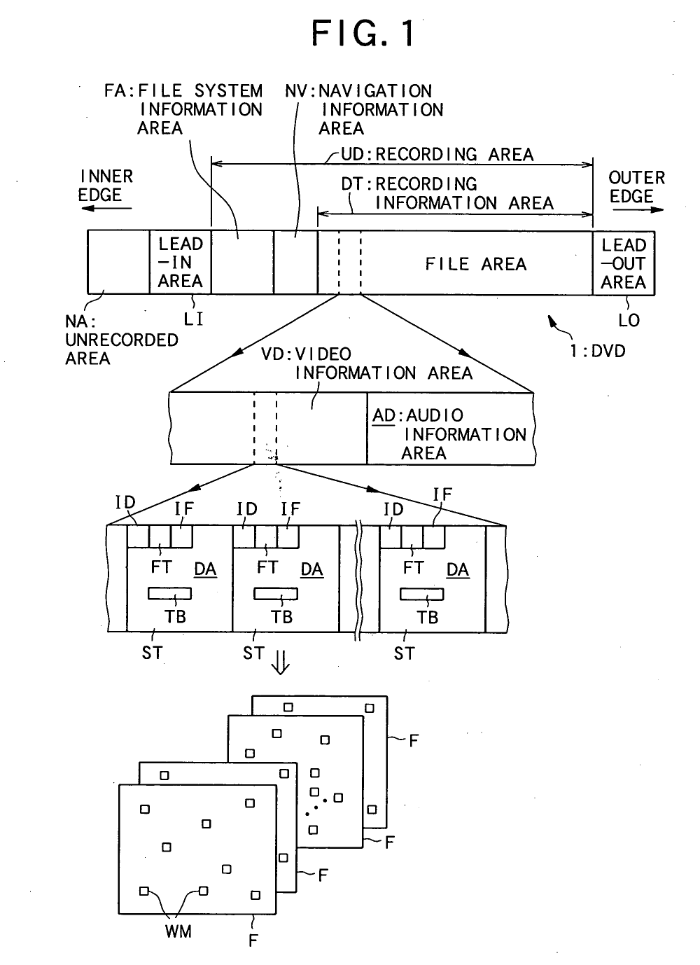

Referring to FIGS. 1 to 6, the following will first describe Embodiment 1, in which the present invention is applied to the above reproduction restriction and so on during the distribution of a playback only DVD where information is recorded.

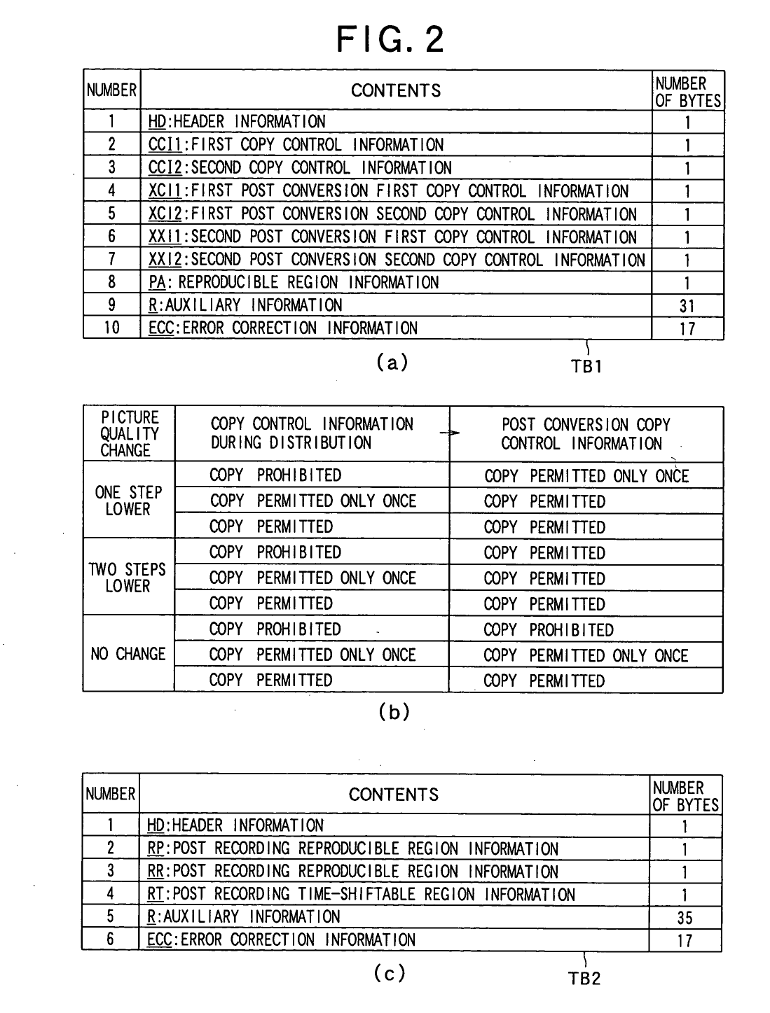

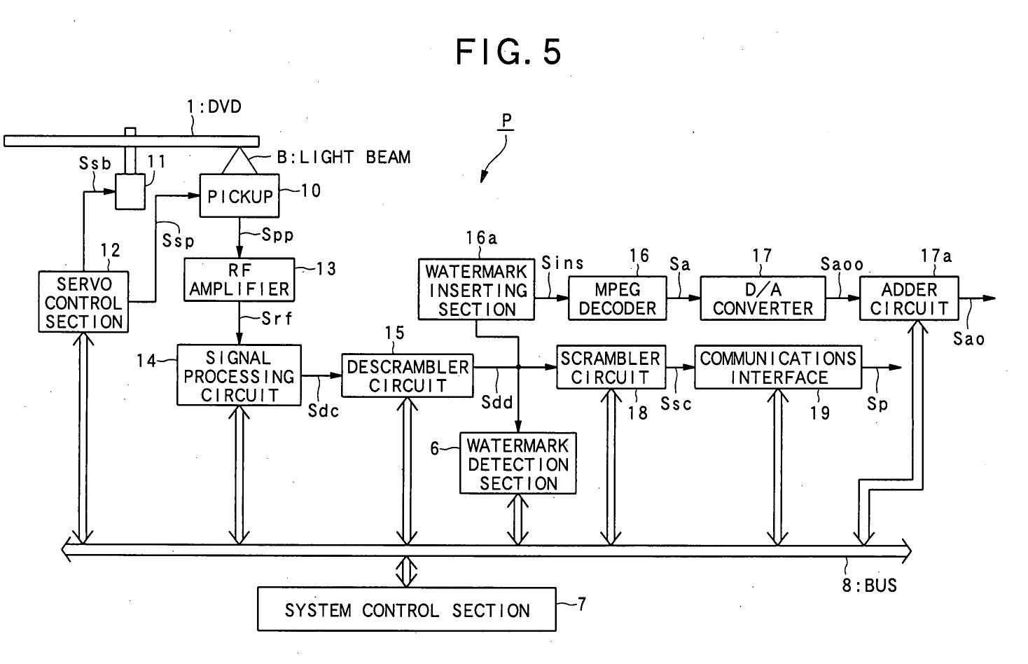

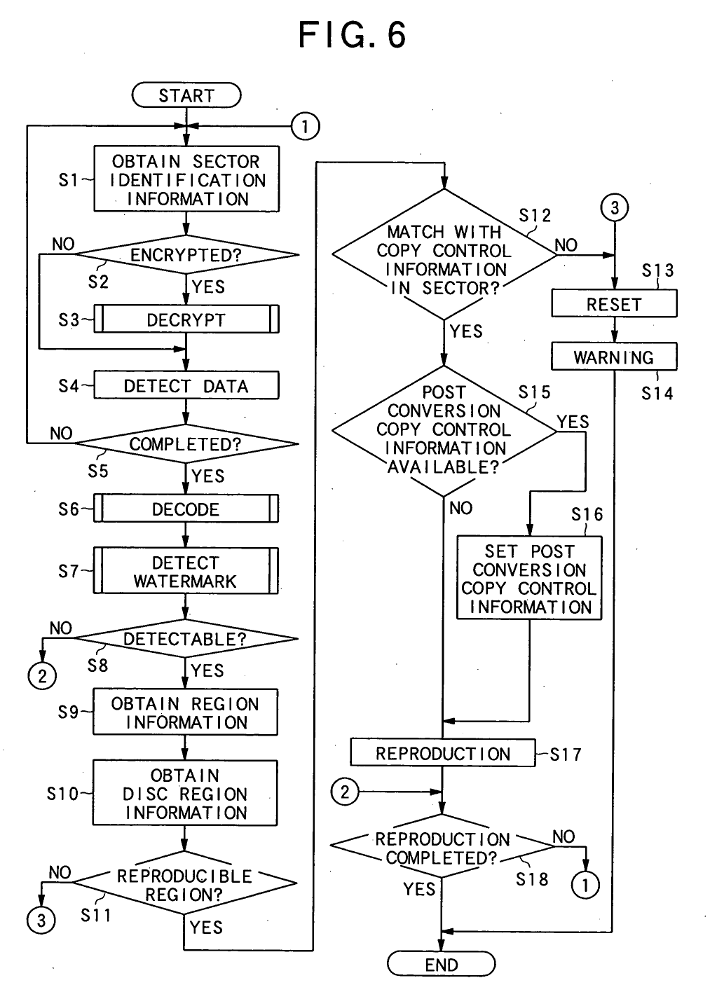

FIG. 1 is a diagram showing a recording pattern of information on a DVD according to Embodiment 1. FIGS. 2 to 4 are diagrams showing the specific contents of information recorded on the DVD. FIG. 5 is a block diagram showing the schematic configuration of an information reproducing apparatus (DVD player) for reproducing information recorded on the DVD. FIG. 6 is a flowchart showing reproduction performed in the DVD player.

Referring to FIGS. 1 to 3, the following will first describe the recording format of information recorded on the playback only DVD according to Embodiment 1.

The following explanation is premised on that information is recorded on the DVD of Embodiment 1, the information indicating countries or regions where the information recorded on the DVD can be reproduced (hereinafter the information which is recorded on the DVD and indicates the countries or regions will be referred to as disc region information).

As shown in the uppermost part of FIG. 1, a playback only DVD 1 of Embodiment 1 is constituted of, from the inner edge, an unrecorded area NA where no information is recorded, a lead-in area LI for recording control information and so on to be first read upon reproduction of recording information recorded in a recording area UD (described later), the recording area UD for recording the recording information to be actually reproduced, the recording information being encrypted as will be described later, and a lead-out area LO for recording end information and so on to be read at the completion of the reproduction of the recording information.

Further, the recording area UD is constituted of, from the inner edge, file system information area FA for recording file system information and so on indicating an information hierarchical structure of the recording information to be reproduced, a navigation information area NV for recording so-called navigation information (specifically including order information indicating the order in which pieces constituting the recording information are reproduced, and address information indicating the recording positions of the pieces of the recording information on the DVD 1) for controlling a reproduction pattern of the recording information, and a recording information area DT for recording the recording information to be reproduced.

The following will specifically describe a recording pattern of the recording information according to Embodiment 1.

First, as shown in the second uppermost part of FIG. 1, the recording information includes one or more pieces of video information VD, which is an image sequence of two or more static images, and audio information AD including only voice information or sound information. The video information VD is constituted of two or more pieces of sector information ST.

In this case, as shown in the third uppermost part of FIG. 1, one piece of the sector information ST is constituted of, from the start, identification information ID including a sector information number for identifying the sector information ST including the identification information ID in the video information VD, correction information FT including an error correction code for correcting an error in the detection of the identification information ID, copy control information IF for restricting the number of times of copying when image information recorded in the sector information ST is copied after reproduction, and image information DA to be actually displayed in addition to the identification information ID. The copy control information IF stores copy control information which indicates, in each of the eight regions of the world divided as will be described later, whether recording information recorded as the image information DA can be freely copied, can be copied and recorded only once, or cannot be copied at all.

Moreover, the image information DA in each piece of the sector information ST includes an information table TB for describing disc region information and so on according to Embodiment 1. In other words, the information table TB is an information table corresponding to the playback only DVD 1.

The following will specifically describe static images included as the image information DA in each piece of the sector information ST. As shown in the lowermost part of FIG. 1, in a frame F serving as the static image, disc region information and so on described as the information table TB is embedded as watermarks WM in bits on eight places (that is, eight bits in one frame F). At this point, disc region information to be included in one information table TB is embedded over a plurality of frames F. Then, during the reproduction of the image information DA, the contents of the information table TB embedded as the watermark WM are detected and decrypted, so that reproduction and so on are restricted according to the disc region information in the information table TB.

Referring to FIGS. 2 to 4, the following will specifically describe the contents of the information table TB of the playback only DVD 1 that is included in the sector information ST.

That is, as shown in FIGS. 2(a) and 2(c), the information table TB includes a first information table TB1 (56 bytes in total in FIG. 2(a)) and a second information table TB2 (56 bytes in total in FIG. 2(c)). At this point, each of the information tables TB has 56 bytes of information, so that the information table TB is constituted of watermarks WM included in the 112 (56×2) frames F in FIG. 1.

Further, as shown in FIG. 2(a), the first information table TB1 includes, from the first byte, header information HD (1 byte) indicating that subsequent information is included in the first information table TB1, first copy control information CCI1 (1 byte) which is copy control information about four of eight divided regions of the world, second copy control information CCI2 (1 byte) which is copy control information about the other four of the eight regions, first post conversion first copy control information XCI1 (1 byte) which is copy control information to be included in recording information reproduced with degraded picture quality, the picture quality or the like being degraded during the reproduction of the recording information recorded on the DVD 1 in the same four regions as the first copy control information CCI1, first post conversion second copy control information XCI2 (1 byte) which is copy control information to be included in recording information reproduced with degraded picture quality, the picture quality or the like being degraded during the reproduction of the recording information recorded on the DVD 1 in the same other four regions as the second copy control information CCI2, second post conversion first copy control information XXI1 (1 byte) which is copy control information to be included in recording information reproduced with degraded picture quality, the picture quality or the like being degraded more than the first post conversion first copy control information XCI1 during the reproduction of the recording information recorded on the DVD 1 in the same four regions as the first copy control information CCI1, second post conversion second copy control information XXI2 (1 byte) which is copy control information to be included in recording information reproduced with degraded picture quality, the picture quality or the like being degraded more than the first post conversion second copy control information XCI2 during the reproduction of the recording information recorded on the DVD 1 in the same other four regions as the second copy control information CCI2, reproducible region information PA (1 byte) serving as disc region information indicating countries or regions where recording information recorded on the DVD 1 can be reproduced, auxiliary information R (31 bytes) including no significant information, and error correction in formation ECC (17 bytes) used for error correction when the first information table TB1 is detected during the reproduction of the image information DA.

The contents of the first post conversion first copy control information XCI1, the first post conversion second copy control information XCI2, the second post conversion first copy control information XXI1, and the second post conversion second copy control information XXI2 will be discussed below. The specific contents are shown in the chart of FIG. 2(b). When picture quality degradation at a predetermined first step is performed on the picture quality and so on of recording information (restrictive conditions of copying are applied which are indicated by the first copy control information CCI1 and the second copy control information CCI2) at the distribution of the DVD 1, the contents of the first post conversion first copy control information XCI1 and the first post conversion second copy control information XCI2 are provided as below. In a region where the first copy control information CCI1 or the second copy control information CCI2 indicates “copy prohibited,” the contents of the first post conversion first copy control information XCI1 or first post conversion second copy control information XCI2 corresponding to the region indicate “copy permitted only once.” In a region where the first copy control information CCI1 or the second copy control information CCI2 indicates “copy permitted only once,” the contents of the first post conversion first copy control information XCI1 or first post conversion second copy control information XCI2 corresponding to the region indicate “copy permitted.” In a region where the first copy control information CCI1 or the second copy control information CCI2 indicates “copy permitted,” the contents of the first post conversion first copy control information XCI1 or first post conversion second copy control information XCI2 corresponding to the region similarly indicate “copy permitted.”

When picture quality degradation at a predetermined second step is performed on the picture quality and so on of recording information (processing for degrading picture quality more than the first step) at the distribution of the DVD 1, the contents of the first post conversion first copy control information XCI1 and the first post conversion second copy control information XCI2 are provided as below. In all of a region where the first copy control information CCI1 or the second copy control information CCI2 indicates “copy prohibited”, a region where the information indicates “copy permitted only once,” and a region where the information indicates “copy permitted,” the contents of the first post conversion first copy control information XCI1 or first post conversion second copy control information XCI2 corresponding to each of the regions similarly indicate “copy permitted.”

Besides, when any of the picture quality degradation is not performed and thus picture quality is not degraded at all during the reproduction of recording information, the contents of the first copy control information CCI1 or the second copy control information CCI2 are not changed at all as shown in FIG. 2(b).

As shown in FIG. 2(c), the second information TB2 includes, from the first byte, header information HD (1 byte) indicating that subsequent information is included in the second information table TB2, post recording reproducible region information RP (1 byte) serving as disc region information which indicates regions where reproduction can be performed again after recording information reproduced from the DVD 1 is recorded on another recording medium such as an optical disc in each of the eight divided regions of the world, post recording recordable region information RR (1 byte) serving as disc region information which indicates regions where copying and recording can be performed on still another recording medium after recording information reproduced from the DVD 1 is recorded on another recording medium such as an optical disc in each of the eight divided regions, post recording time-shiftable region information RT (1 byte) serving as disc region information which indicates regions where reproduction (so-called time-shift reproduction) can be performed after a predetermined time from when recording information reproduced from the DVD 1 is recorded on another recording medium such as an optical disc in each of the eight divided regions, auxiliary information R (35 bytes) including no significant information, and error correction information ECC (17 bytes) used for error correction when the second information table TB2 is detected during the reproduction of the image information DA.

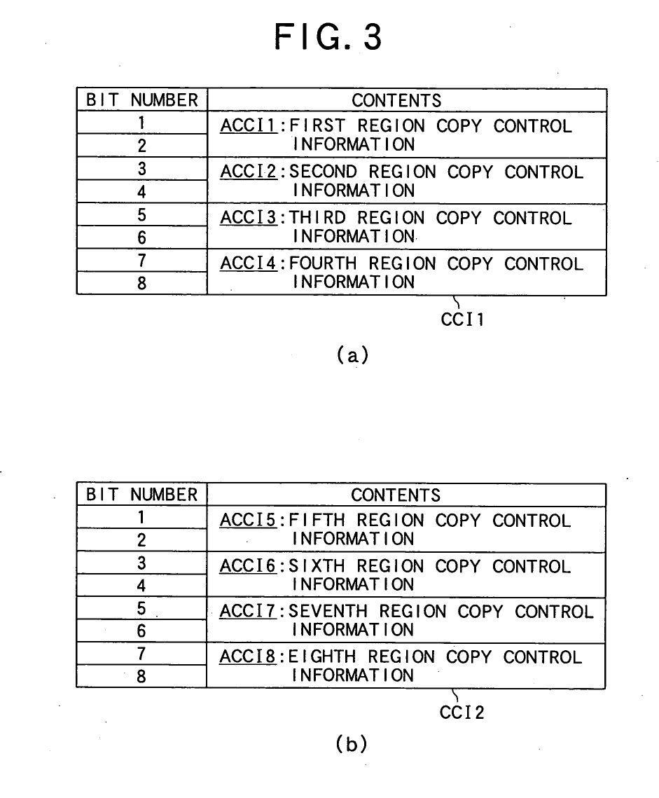

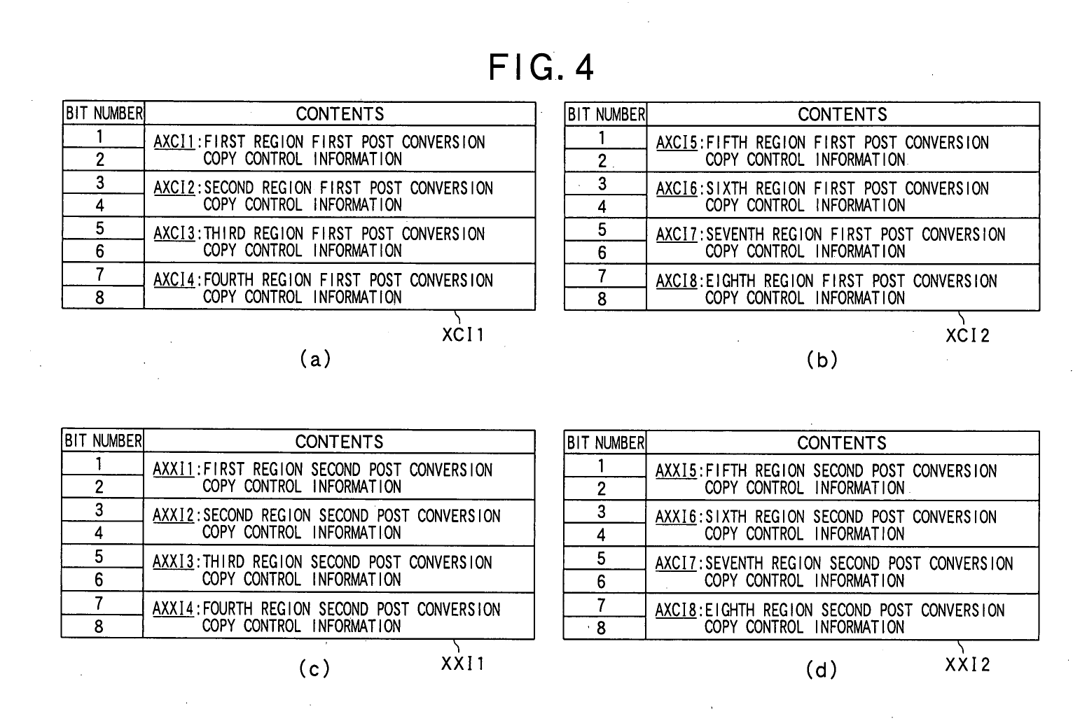

Referring to FIGS. 3 and 4, the detail of the first information table TB1 will be described below.

First, as shown in FIG. 3(a), the first copy control information CCI1 included in the first information table TB1 is constituted of first region copy control information ACCI1 (2 bits) which is copy control information used for a first region (e.g., North America) of the eight regions, second region copy control information ACCI2 (2 bits) which is copy control information used for a second region (e.g., Japan) of the eight regions, third region copy control information ACCI3 (2 bits) which is copy control information used for a third region (e.g., Europe) of the eight regions, and fourth region copy control information ACCI4 (2 bits) which is copy control information used for a fourth region of the eight regions.

Further, as shown in FIG. 3(b), the second copy control information CCI2 included in the first information table TB1 is constituted of fifth region copy control information ACCI5 (2 bits) which is copy control information used for a fifth region of the eight regions, sixth region copy control information ACCI6 (2 bits) which is copy control information used for a sixth region of the eight regions, seventh region copy control information ACCI7 (2 bits) which is copy control information used for a seventh region of the eight regions, and eighth region copy control information ACCI8 (2 bits) which is copy control information used for an eighth region of the eight regions.

The contents of the region copy control information ACCI shown in FIG. 3 will be specifically discussed below. The first region copy control information ACCI1 corresponding to the first region is used as an example. When the copying of recording information recorded on the DVD 1 is not restricted in the first region (in other words, the recording information can be freely copied and recorded), the first region copy control information ACCI1 has “00b (“b” indicates a binary number, which also applies to the explanation below).” When the recording information can be copied and recorded only once in the first region, the first region copy control information ACCI1 has “10b”. When the recording information cannot be copied or recorded at all in the first region, the first region copy control information ACCI1 has“11b”. A value “01b” of the first region copy control information ACCI1 is an auxiliary value which is not used under normal conditions.

Moreover, as shown in FIG. 4(a), the first post conversion first copy control information XCI1 included in the first information table TB1 is constituted of first region first post conversion copy control information AXCI1 (2 bits) which is copy control information used for the first region and is copy control information used when picture quality degradation at the first step is performed during reproduction, second region first post conversion copy control information AXCI2 (2 bits) which is copy control information used for the second region and is copy control information used when picture quality degradation at the first step is performed, second region first post conversion copy control information AXCI3 (2 bits) which is copy control information used for the third region and is copy control information used when picture quality degradation at the first step is performed, and second region first post conversion copy control information AXCI4 (2 bits) which is copy control information used for the fourth region and is copy control information used when picture quality degradation at the first step is performed.

Further, as shown in FIG. 4(b), the first post conversion second copy control information XCI2 included in the first information table TB1 is constituted of fifth region first post conversion copy control information AXCI5 (2 bits) which is copy control information used for the fifth region and is copy control information used when picture quality degradation at the first step is performed during reproduction, sixth region first post conversion copy control information AXCI6 (2 bits) which is copy control information used for the sixth region and is copy control information used when picture quality degradation at the first step is performed, seventh region first post conversion copy control information AXCI7 (2 bits) which is copy control information used for the seventh region and is copy control information used when picture quality degradation at the first step is performed, and eighth region first post conversion copy control information AXCI8 (2 bits) which is copy control information used for the eighth region and is copy control information used when picture quality degradation at the first step is performed.

Besides, as shown in FIG. 4(c), the second post conversion first copy control information XXI1 included in the first information table TB1 is constituted of first region second post conversion copy control information AXXI1 (2 bits) which is copy control information used for the first region and is copy control information used when picture quality degradation at the second step is performed during reproduction, second region second post conversion copy control information AXXI2 (2 bits) which is copy control information used for the second region and is copy control information used when picture quality degradation at the second step is performed, third region first post conversion copy control information AXXI3 (2 bits) which is copy control information used for the third region and is copy control information used when picture quality degradation at the second step is performed, and fifth region first post conversion copy control information AXXI4 (2 bits) which is copy control information used for the fourth region and is copy control information used when picture quality degradation at the second step is performed during reproduction.

Finally, as shown in FIG. 4(d), the second post conversion second copy control information XXI1 included in the first information table TB1 is constituted of fifth region second post conversion copy control information AXXI5 (2 bits) which is copy control information used for the fifth region and is copy control information used when picture quality degradation at the second step is performed during reproduction, sixth region second post conversion copy control information AXXI6 (2 bits) which is copy control information used for the sixth region and is copy control information used when picture quality degradation at the second step is performed, seventh region second post conversion copy control information AXXI7 (2 bits) which is copy control information used for the seventh region and is copy control information used when picture quality degradation at the second step is performed, and eighth region second post conversion copy control information AXXI8 (2 bits) which is copy control information used for the eighth region and is copy control information used when picture quality degradation at the second step is performed.

Regarding the specific contents of the region post conversion copy control information AXCI or AXXI shown in FIG. 4, copy control information having the contents of FIG. 2(b) is described for each region at each step of picture quality degradation.

In the reproducible region information PA included in the first information table TB1, 1-bit information is assigned for each of the regions. The information indicates whether recording information recorded on the DVD 1 can be reproduced or not in each of the eight regions.

Regarding a concrete value of the reproducible region information PA for each of the regions, when recording information recorded on the DVD 1 can be reproduced in a region, reproducible information corresponding to the region has “1b”. When the recording information cannot be reproduced in the region, the reproducible information corresponding to the region has “0b”.

Further, in the post recording reproducible region information RP included in the second information table TB2, 1-bit information is assigned for each of the regions. The information indicates whether reproduction is permitted in each of the eight regions after recording information recorded on the DVD 1 is reproduced and is recorded on another recording medium (to be specific, a recordable optical disc and so on).

Regarding a concrete value of the post recording reproducible information RP for each of the regions, when reproduction is permitted in a region after recording information recorded on the DVD 1 is reproduced and recorded on another recording medium, post recording reproducible information corresponding to the region has “1b”. When reproduction is not permitted in the region after the recording information is reproduced and recorded on another recording medium, the post recording reproducible information corresponding to the region has “0b”.

Moreover, in the post recording recordable region information RR included in the second information table TB2, 1-bit information is assigned for each of the regions. The information indicates whether recording information can be copied and recorded on still another recording medium in each of the eight regions after the recording information recorded on the DVD 1 is reproduced and recorded on another recording medium.

Regarding a concrete value of the post recording recordable information RR for each of the regions, when the recording information can be copied and recorded on still another recording medium in a region after the recording information recorded on the DVD 1 is reproduced and recorded on another recording medium, post recording recordable information RR corresponding to the region has “1b”. When the recording information cannot be copied or recorded in the region, the post recording recordable information corresponding to the region has “0b”.

Finally, in the post recording time-shiftable region information RT included in the second information table TB2, 1-bit information is assigned for each of the regions. The information indicates whether time shift reproduction is permitted in each of the eight regions after recording information reproduced from the DVD 1 is recorded on another recording medium.

Regarding a concrete value of the post recording time-shiftable region information RT for each of the regions, when time shift reproduction is permitted in a region after the recording information recorded on the DVD 1 is recorded on another recording medium, the post recording time-shiftable region information RT corresponding to the region has “1b”. When time shift reproduction is not permitted in the region, the post recording time-shiftable region information RT corresponding to the region has “0b”.

Referring to FIGS. 5 and 6, the following will discuss an embodiment of a DVD player serving as an information reproducing apparatus for reproducing recording information from the DVD 1, on which the recording information is recorded in the above format.

FIG. 5 is a block diagram showing the schematic configuration of the DVD player. FIG. 6 is a flowchart showing reproduction performed in the DVD player.

The following explanation is premised on that the DVD player of Embodiment 1 stores information indicating countries or regions where the DVD player should be installed and operated (hereinafter the information indicating the countries or regions will be referred to as region information).

As shown in FIG. 5, a DVD player P for reproducing and outputting recording information recorded on the playback only DVD 1 of Embodiment 1 is constituted of a pickup 10, a spindle motor 11, a servo control section 12, an RF (Radio Frequency) amplifier 13, a signal processing circuit 14, a descrambler circuit 15, an MPEG (Moving Picture Expert Group) decoder 16, a watermark inserting section 16a, a D/A (Digital/Analog) converter 17, an adder circuit 17a, a scrambler circuit 18, a communications interface 19, a watermark detecting section 6, and a system control section 7 serving as adding means, changing means setting means, and outputting means. The servo control section 12, the signal processing circuit 14, the descrambler circuit 15, the scrambler circuit 18, the communications interface 19, the watermark detecting section 6, and the system control section 7 are connected to one another via a bus 8 so that control information and so on can be sent and received to and from one another. Further, the system control section 7 stores region information indicating countries or regions where the DVD player P should be installed and operated.

Operations will be discussed below.

First, recording information to be reproduced is compressed by a predetermined compression method (to be specific, so-called MPEG, etc.) and is recorded on the DVD 1 as described above. Further, the recording information is encrypted by a predetermined encryption scheme and is recorded. The first information table TB1 and the second information table TB2 are embedded as the watermarks WM for each of the fields F in the recording information.

Moreover, the DVD player P can reproduce the recording information from the DVD 1 and output the information in a digital manner to an external network and so on via the communications interface 19 without decoding, and the DVD player P can reproduce and decode the recording information and directly output the information as analog information to a display or speaker (not shown).

When the recording information is reproduced from the DVD 1, the DVD 1 is first rotated at a predetermined rotational speed by the spindle motor 11 in the DVD player P. The spindle motor 11 is driven in response to a spindle control signal Ssb (described later).

Then, the pickup 10 irradiates the rotating DVD 1 with a light beam B for reproduction with a constant intensity, receives reflected light of the light beam B from the DVD 1 to generate a detection signal Spp corresponding to the recorded recording information, and outputs the signal to the RF amplifier 13.

At this point, an actuator (not shown) for changing the position of an object lens (not shown) for condensing the light beam B on an information track is driven by a pickup servo signal Ssp outputted from the servo control section 12, so that a displacement of the focusing position of the light beam B is eliminated relative to the position of the information track where recording information to be reproduced is recorded on the DVD 1.

Then, the RF amplifier 13 amplifies the detection signal Spp and outputs the signal as an RF signal Srf to the signal processing circuit 14.

Subsequently, the signal processing circuit 14 performs processing such as waveform shaping on the RF signal Srf under the control of the system control section 7 via the bus 8, generates a processing signal Sdc, and outputs the signal to the descrambler circuit 15.

Then, under the control of the system control section 7 via the bus 8, the descrambler circuit 15 decrypts the encryption of the recording information, which is included in the processing signal Sdc, generates a decryption signal Sdd, and outputs the signal to the watermark inserting section 16a, the scrambler circuit 18, and the watermark detecting section 6.

Thus, under the control of the system control section 7 via the bus 8, the watermark detecting section 6 detects the first information table TB1 and the second information table TB2, which are included in the decryption signal Sdd, and outputs the contents to the system control section 7.

Then, the system control section 7 controls the constituent members in such a manner as to restrict the reproduction of recording information in the DVD 1 according to the outputted contents of the first information table TB1 and the second information table TB2.

Regarding the specific configuration of the detail of the watermark detecting section 6, a watermark detecting section configured as disclosed in paragraphs [0035] to [0053] and FIG. 3 of Japanese Patent Laid-Open No. 11-98341 is suitable.

The watermark inserting section 16a fed with the decryption signal Sdd inserts, into the decryption signal Sdd, watermarks to be inserted to image information which has been reproduced in an analog manner. Then, the watermark inserting section 16a generates an insertion decryption signal Sins and outputs the signal to the MPEG decoder 16.

The MPEG decoder 16 expands recording information included in the insertion decryption signal Sins according to an expansion method corresponding to the compression method used for the insertion decryption signal Sins, generates an expansion signal Sa, and outputs the signal to the D/A converter 17. At this point, in the MPEG decoder 16, when reproduction in the DVD player P is determined beforehand as reproduction with image degradation at the first step or image degradation at the second step, necessary picture quality degradation is performed along with the expansion, and then, the expansion signal Sa is generated.

Then, the D/A converter 17 converts the expansion signal Sa into an analog signal to generate an analog output signal Saoo and outputs the signal to the adder circuit 17a.

Thereafter, the adder circuit 17a superimposes copy control information, which has the same contents as copy control information inserted as watermarks by the watermark inserting section 16a, on the reproduced analog output signal Saoo in an analog manner, generates an analog output signal Sao, and outputs the signal to the display, speaker or the like.

Under the control of the system control section 7 via the bus 8, the scrambler circuit 18 fed with the decryption signal Sdd encrypts the decryption signal Sdd again using a predetermined encryption key in the communications interface 19, generates an encryption signal Ssc, and outputs the signal to the communications interface 19. At this point, recording information included in the encryption signal Ssc is not subjected to so-called decoding or the picture quality degradation but is outputted as it is to the communications interface 19.

Then, under the control of the system control section 7 via the bus 8, the communications interface 19 performs predetermined output interface processing on the encryption signal Ssc and outputs the signal as demodulation information Sp to the external network and so on.

In parallel with the operations of the constituent members, the system control section 7 restricts reproduction in the above-described manner and exercises control over the operations of the constituent members.

Referring to the flowchart of FIG. 6, the following will summarize information reproduction (including a restriction on reproduction according to the copy control information) for reproducing information from the DVD 1 in the DVD player P configured thus and information reproduction having the picture quality degradation. The following will describe processing for outputting recording information recorded on the DVD 1 to the display or speaker as the analog output signal Sao.

As shown in FIG. 6, in the information reproduction of Embodiment 1, the light beam B for reproduction is first emitted to a recording position on the DVD 1 where recording information to be reproduced is recorded, the sector information ST (FIG. 1) having been recorded on the recording position is read, and the identification information ID is detected from the sector information ST (step S1).

Then, information in the sector information ST is read that is reproduced subsequently to the identification information ID and it is confirmed whether the information is encrypted or not (step S2). When the information is not encrypted (step S2; NO), the process advances to step S4 (described later). When the information is encrypted (step S2; YES), the encryption is decrypted in the descrambler circuit 15 (step S3). The recording information is read while being decrypted (step S4).

Subsequently, it is monitored all the time whether the reading of necessary information is completed or not during the reading of the recording information (step S5). When the reading is not completed (step S5; NO), the process returns to step S1 to reproduce subsequent recording information in the sector information ST. When the reading of necessary information is completed (step S5; YES), the read recording information (decryption signal Sdd) is decoded in the MPEG decoder 16 in order to output the information as the analog output signal Sao (step S6) and the watermarks WM are detected from information corresponding to the sector information ST included in the decryption signal Sdd (step S7).

Then, it is confirmed whether the watermarks WM are detected or not (step S8). When the watermarks WM are not detected (step S8; NO), it is decided that reproduction restriction is not necessary for the recording information recorded on the DVD 1, which is currently loaded in the DVD player P, and the process advances to the processing of step S18 (described later). When the watermarks WM are detected (step S8; YES), region information is acquired which is stored in the system control section 7 and corresponds to the DVD player P (step S9). Then, the contents of the first information table TB1 and the second information table TB2 are extracted from the watermarks WM detected in step S8 and are decrypted in the watermark detecting section 6, and the reproducible region information PA or the like is obtained as disc region information (step S10).

Subsequently, based on the obtained reproducible region information PA, it is confirmed whether the recording information recorded on the DVD 1 can be reproduced or not in regions indicated by the region information obtained in step S9, that is, in countries or regions where the DVD player P should be installed and operated (step S11). Then, when the reproducible region information PA indicates that the installation region of the DVD player P is not a region where recording information can be reproduced (step S11; NO), the recording information cannot be reproduced by the DVD player P. Thus, the DVD player P is reset to forcefully terminate the reproduction of the recording information recorded on the DVD 1 in the DVD player P (step S13), a warning that the recording information cannot be reproduced is issued on a display (not shown) and so on (step S14), and a series of reproducing operations is completed.

In the decision of step S11, when the reproducible region information PA indicates that the installation region of the DVD player P is a region where recording information can be reproduced (step S11; YES), confirmation is made on the contents of the copy control information IF in each piece of the sector information ST and the contents of the region copy control information ACCI in the detected (steps S7 and S8) first information table TB1, and it is confirmed whether or not the contents of the copy control information IF corresponding to a region indicated by the region information match with the contents of the region copy control information ACCI corresponding to the region (that is, whether any one of the information IF and the information ACCI is illegally tampered or not) (step S12).

When the contents of the copy control information IF corresponding to the region indicated by the region information match with the contents of the region copy control information ACCI corresponding to the region (step S12; YES), it is decided that illegal tampering or the like is not performed on the DVD 1. Subsequently, it is confirmed whether the currently performed information reproduction has any of the picture quality degradation and it is confirmed whether decoded (step S6) recording information includes any of the first post conversion first copy control information XCI1 and the first post conversion second copy control information XCI2 or the second post conversion first copy control information XXI1 and the second post conversion second copy control information XXI2 (step S15).

When the recording information has any of the picture quality degradation and includes the post conversion copy control information (step S15; YES), the contents of the picture quality degradation (i.e., picture quality degradation at the first step or picture quality degradation at the second step) and the post conversion copy control information corresponding to the region indicated by the region information are set in the watermark inserting section 16a and the adder circuit 17a as copy control information to be included in recording information outputted as the analog output signal Sao (step S16). Then, reproduction is performed to output the decoded (step S6) recording information with the copy control information as the analog output signal Sao (step S17).

Additionally, when it is decided in step S15 that the information reproduction of FIG. 6 does not include any of the picture quality degradation or the decoded (step S6) recording information does not include any one of the post conversion copy control information (step S15; NO), the process advances to the reproduction of step S17 (reproduction not including copy control information).

Then, it is monitored all the time whether necessary recording information is completely reproduced or not during reproduction (step S18). When reproduction is completed (step S18; YES), the reproducing process is completed. When the reproduction is not completed (step S18; NO), the process returns to step S1 to continue the series of reproducing operations.

When it is decided in step S12 that the contents of the copy control information IF corresponding to a region indicated by the region information does not match with the contents of the region copy control information ACCI corresponding to the region (step S12; NO), illegal tampering or the like may be performed on the DVD 1. Therefore, it is decided that recording information recorded on the currently loaded DVD 1 should not be reproduced. The DVD player P is reset to forcefully terminate reproduction performed in the DVD player P (step S13), a warning that the recording information cannot be reproduced is issued on the display (not shown) and so on (step S14), and a series of reproducing operations is terminated.

When picture quality degradation is not performed during reproduction in Embodiment 1, the first copy control information CCI1 and the second copy control information CCI1, which have been recorded on the DVD 1, are included as they are in the reproduced recording information.

As described above, according to the recording format of the DVD 1 and the operations of the DVD player P of Embodiment 1, recording information on the DVD 1 includes the first post conversion first copy control information XCI1 and first post conversion second copy control information XCI2 or the second post conversion first copy control information XXI1 and the second post conversion second copy control information XXI2, and the first copy control information CCI1 and the second copy control information CCI2. When picture quality and so on are degraded during the reproduction of the recording information, post conversion copy control information corresponding to the degradation of picture quality and so on is superimposed on the reproduced recording information before being outputted. When picture quality and soon are maintained during the reproduction of the recording information, the first copy control information CCI1 and the second copy control information CCI2 are superimposed on the reproduced recording information before being outputted. Therefore, it is possible to change the contents of the subsequent restriction on copying according to a change in picture quality and so on during reproduction, thereby effectively protecting the copyright of the recording information.

Further, when reproduction is performed after the picture quality and so on of recording information are degraded, post conversion copy control information is superimposed with more moderate restrictive conditions of copying. Thus, regarding recording information degraded in picture quality and so on during reproduction, copying is restricted under moderate restrictive conditions. Meanwhile, in the case of recording information not being degraded in picture quality and so on during reproduction, copying can be restricted by the original first copy control information CCI1 and second copy control information CCI2. Hence, the restrictive conditions of copying can be made moderate or strict according to the quality of recording information, so that it is possible to widely distribute the recording information while adjusting interests between the creator and the user of the recording information and it is possible to -widely and properly restrict the copying of the recording information, thereby effectively protect the copyright of the recording information.

### (II) Embodiment 2

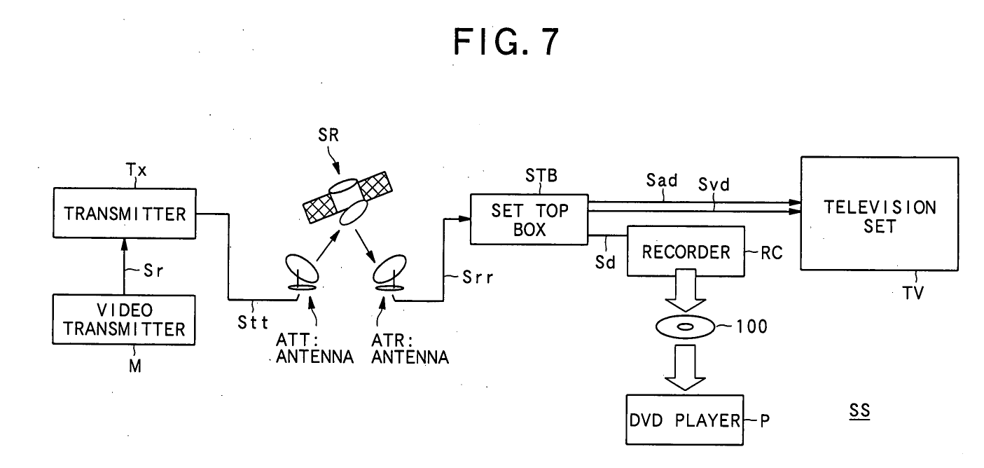

Referring to FIGS. 7 to 14, the following will discuss Embodiment 2, which is another embodiment of the present invention.

In Embodiment 2 described below, the present invention is applied to the case where the reproduction or recording of recording information is restricted at the destination in an information transmission system for transmitting the recording information, which includes at least image information, via satellite airwaves.

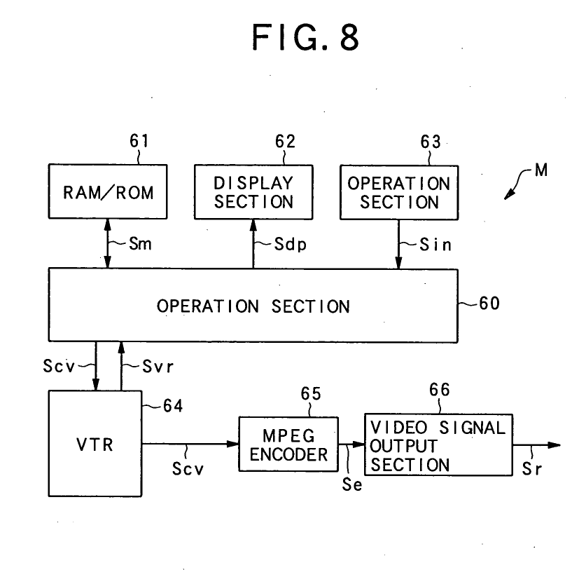

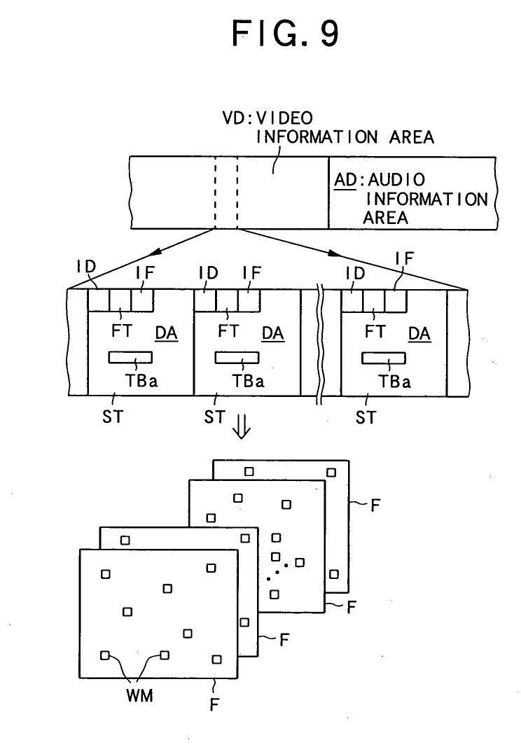

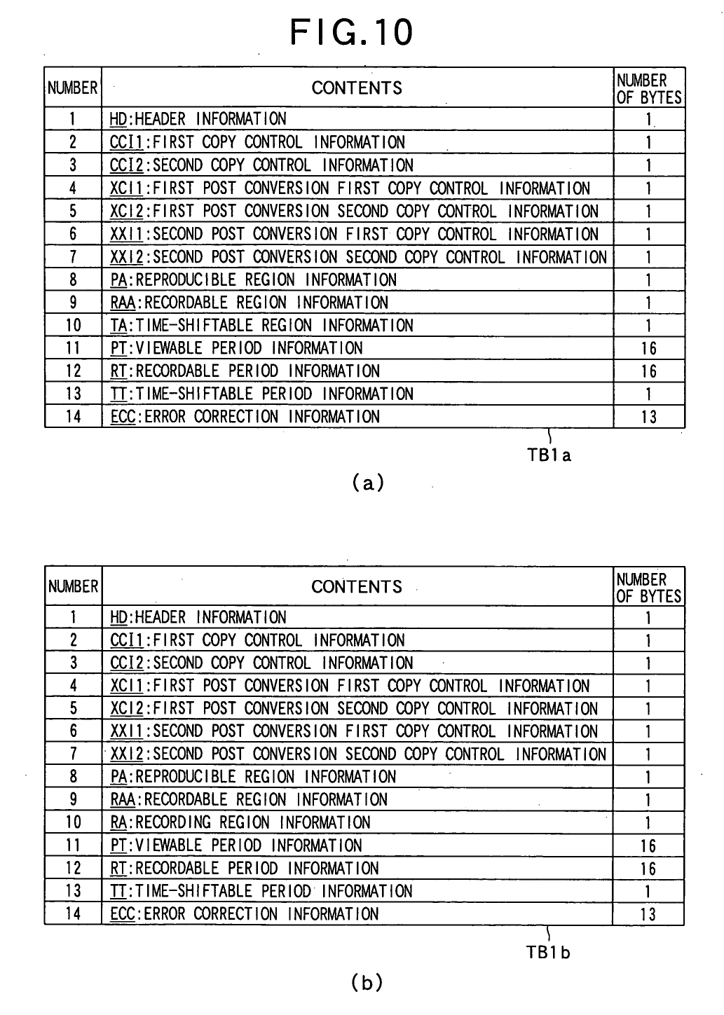

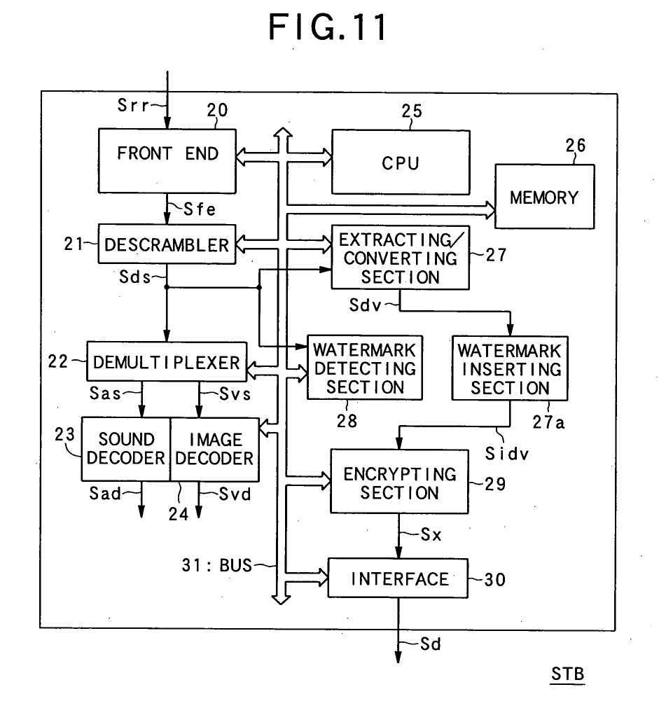

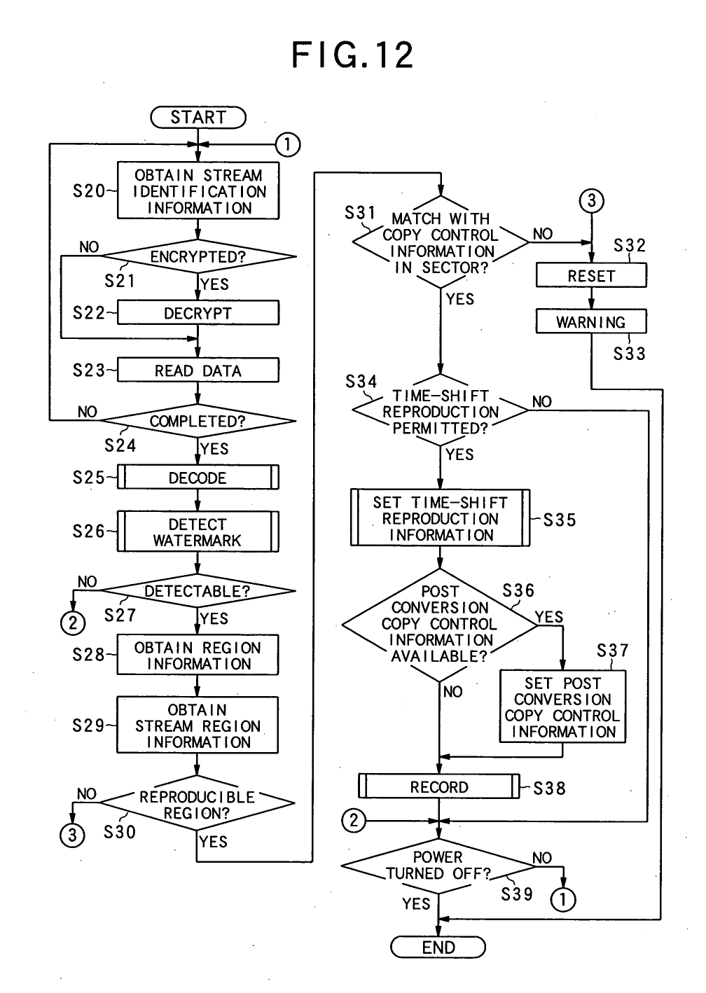

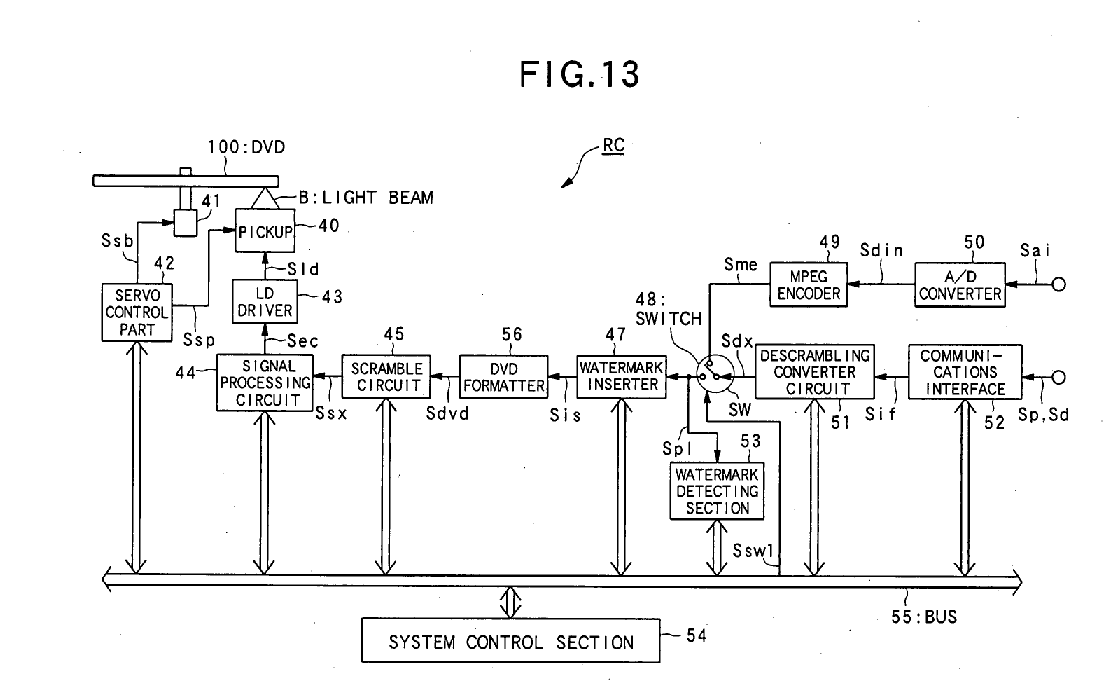

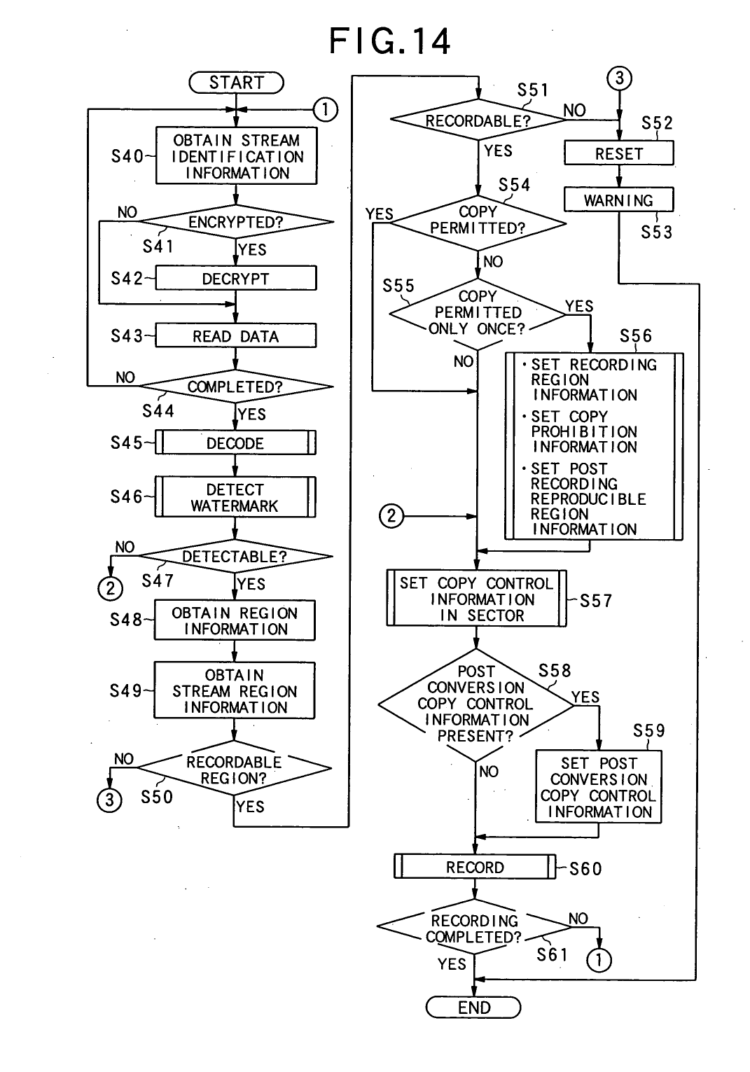

FIG. 7 is a block diagram showing the schematic configuration of the information transmission system of Embodiment 2. FIG. 8 is a block diagram showing the schematic configuration of a video transmitter included in the information transmission system. FIG. 9 is a diagram showing a format of recording information transmitted in the information transmission system. FIG. 10 is a diagram showing the specific contents of the transmitted recording information. FIG. 11 is a block diagram showing the schematic configuration of a set-top box included in the information transmission system. FIG. 12 is a flowchart showing a receiving operation performed in the set-top box. FIG. 13 is a block diagram showing the schematic configuration of a recorder included in the information transmission system. FIG. 14 is a flowchart showing a recording operation performed in the recorder.

First, the overall configuration of the information transmission system will be described below according to Embodiment 2. As shown in FIG. 7, the information transmission system SS is constituted of a video transmitter M, a transmitter TX, antennas ATT and ATR, a communications satellite SR which is a geostationary satellite launched into space, a set-top box STB, a television set TV, a recorder RC, and a DVD player P which performs the same operations with the same configuration as Embodiment 1.

The outline of operations will be discussed below.

First, the video transmitter M generates recording information to be transmitted by using the information transmission system SS in such a manner as to include information tables in formats which will be described later. Then, the video transmitter M outputs the recording information to the transmitter TX as an equivalent recording information signal Sr.

Thus, the transmitter TX performs predetermined modulation or the like on the recording information signal Sr and outputs the recording information signal Sr to the transmitting antenna ATT as an output signal Stt for satellite communication.

Then, the antenna ATT converts the output signal Sr into radio waves for satellite transmission and transmits the radio waves to the communications satellite SR. At this point, the output signal Sr is encrypted by a predetermined encryption scheme before being transmitted as radio waves to the communications satellite SR.

Subsequently, the communications satellite SR receives radio waves corresponding to the output signal, and relays and transmits the output signal to the receiving antenna ATR.

Hence, the antenna ATR receives the relayed radio waves, generates an equivalent received signal Srr, and outputs the signal to the set-top box STB.

Then, the set-top box STB demodulates the received signal Srr, decrypts the encryption having been performed upon transmission, generates an image signal Svd corresponding to image information included in transmitted recording information and a sound signal Sad corresponding to sound information included in the recording information, outputs the signals to the television set TV, demodulates the received signal Srr, encrypts the signal again according to an encryption scheme different from that of the encryption performed upon transmission, generates a digital output signal Sd serving as a digital signal, and outputs the signal to the recorder RC.

With these operations, the television set TV displays an image inputted as the image signal Svd on a display (not shown) and outputs sound inputted as the sound signal Sad from a speaker (not shown).

The recorder RC fed with the digital output signal Sd records an image and sound, which are included in the digital output signal Sd, on a recordable DVD 100 according to recording restriction information which is included in the information tables (information tables for restricting recording, described later) included in the digital output signal Sd.

Then, recording information recorded on the DVD 100 is reproduced by the DVD player P according to reproduction restriction information included in the information tables (information tables for restricting reproduction, described later) which are recorded with the recording information by the recorder RC.

In the above operations, picture quality degradation at the first step or picture quality degradation at the second step of Embodiment 2 is performed in only one of the set-top box STB and the recorder RC. The picture quality degradation is not performed in the DVD player P of Embodiment 2.

Referring to FIG. 8, the detailed configuration and operations of the video transmitter M will be described below.

As shown in FIG. 8, the video transmitter M included in the information transmission system SS is constituted of a control section 60, a memory 61 composed of RAM (Random Access Memory) and ROM (Read Only Memory), a display section 62, an operation section 63, a VTR (Video Tape Recorder) 64, an MPEG encoder 65, and a video signal output section 66.

Operations will be discussed below.

First, recording information to be transmitted in the information transmission system SS of Embodiment 2 is recorded beforehand in the VTR 64.

In response to an operation signal Sin corresponding to an operation operated in the operation section 63, the control section 60 transmits and receives necessary information as a memory signal Sm to and from the memory 61. Meanwhile, the control section 60 extracts, from recording information recorded in the VTR 64, recording information to be transmitted in the information transmission system SS as recording information Svr. Then, the control section 60 separately generates the information tables to be transmitted (described later) which are superimposed on the extracted recording information Svr, embeds the generated information tables as watermarks in the recording information Svr having been extracted from the VTR 64, and causes the VTR 64 to store recording information Scv again, in which the information tables are embedded. Thereafter, the control section 60 controls the VTR 64 in such a manner as to output the recording information Scv, in which the information tables are embedded, to the MPEG encoder 65 with predetermined timing.

Subsequently, the MPEG encoder 65 compresses and modulates the recording information Scv according to MPEG and outputs the information as modulation information Se to the video signal output section 66.

Then, the video signal output section 66 performs predetermined output processing such as format conversion and encryption on the modulation signal Se and outputs the signal as the recording information signal Sr to the transmitter TX.

Referring to FIGS. 9 to 12, the following will describe a format of recording information outputted as the recording information signal Sr from the video transmitter M.

First, as shown in FIG. 9, the recording information outputted as the recording information signal Sr from the video transmitter M includes at least video information VD constituted of two or more pieces of sector information ST and audio information AD which is sound information corresponding to the video information VD, as in the case of Embodiment 1.

At this point, like Embodiment 1, one piece of the sector information ST is constituted of identification information ID, correction information FT, copy control information IF, and image information DA.

Moreover, the image information DA in each piece of the sector information ST includes an information table TBa for describing region information (hereinafter referred to as stream region information) and so on corresponding to recording information distributed via the communications satellite SR.

The following will specifically describe static images included as the image information DA in each piece of the sector information ST. As shown in the lower part of FIG. 9, in a frame F serving as the static image, stream region information and so on described as the information table TBa is embedded as watermarks WM in bits on eight places as in Embodiment 1. Then, when the recording information including the image information DA is received by the set-top box STB, the contents of the information table TB embedded as the watermark WM are detected and decrypted, so that reproduction and recording are restricted according to the stream region information in the information table TBa.

Referring to FIG. 10, the following will describe the contents of the information table TBa which is included in the sector information ST and serves as recording information for distribution.

First, as shown in FIG. 10, the information table TBa includes one of a first information table TB1a (56 bytes in total) and a first information table TB1b (56 bytes in total) and a second information table TB2 (56 bytes in total) having the same contents as Embodiment 1 (FIG. 2(c)).

At this point, when the recording information for distribution that is outputted from the video transmitter M cannot be copied at the destination, the first information table TB1a shown in FIG. 10(a) and the second information table TB2 are superimposed on the recording information for distribution. When the recording information for distribution can be freely copied at the destination or can be copied only once, the first information table TB1b shown in FIG. 10(b) and the second information table TB2 are superimposed on the recording information for distribution.

Further, as shown in FIG. 10(a), the first information table TB1a includes, from the first byte, header information HD (1 byte) having the same contents as the first information table TB1 of Embodiment 1, first copy control information CCI1 (1 byte), second copy control information CCI2 (1 byte), first post conversion first copy control information XCI1 (1 byte), first post conversion second copy control information XCI2 (1 byte), second post conversion first copy control information XXI1 (1 byte), and second post conversion second copy control information XXI2 (1 byte). In addition, the first information table TB1a describes reproducible region information PA (1 byte) serving as stream region information indicating countries or regions where reproduction is permitted after the distribution of the recording information for distribution. Furthermore, the first information table TB1a includes recordable region information RAA (1 byte) serving as stream region information indicating countries or regions where distributed recording information can be recorded on a recording medium such as the DVD 100, time-shiftable region information TA (1 byte) serving as stream region information indicating counties or regions where distributed recording information can be temporarily recorded and subjected to time-shift reproduction with a time interval, viewable period information PT (16 bytes) indicating, for each region, a period during which distributed recording information can be reproduced and viewed at the destination, recordable period information RT (16 bytes) indicating, for each region, a period during which distributed recording information can be recorded on a recording medium such as the DVD 100 at the destination, time-shiftable period information TT (1 byte) indicating, for each region, a period during which distributed recording information can be subjected to time-shift reproduction at the destination, and error correction information ECC (13 bytes) used for error correction when the first information table TB1a is detected during the reproduction of the image information DA.

As shown in FIG. 10(b), the first information table TB1b describes recording region information RA (1 byte) serving as stream region information indicating countries or regions where distributed recording information is actually recorded on a recording medium such as the DVD 100 by the recorder RC, instead of the time-shiftable region information TA in the first information table TB1a shown in FIG. 10(a). Information other than the recording region information RA in the first information table TB1b is completely similar to that of the first information table TB1a.

The detail of the first information tables TB1a and TB1b will be described below.

First, regarding a concrete value of the recordable region information RAA for each of the regions that is included in the first information tables TB1a and TB1b, when distributed recording information can be recorded on a recording medium such as the DVD 100 in a region, recordable region information corresponding to the region has “1b”. When the recording information cannot be recorded in the region, reproducible information corresponding to the region has “0b”.

Further, regarding a concrete value of the time-shiftable region information TA for each of the regions that is included in the first information table TB1a, when distributed recording information can be subjected to time-shift reproduction in a region, time-shiftable region information corresponding to the region has “1b”. When the recording information cannot be subjected to time-shift reproduction in the region, the time-shiftable region information corresponding to the region has “0b”.

The detailed configurations of the viewable period information PT and recordable period information RT for each region will be discussed below. The viewable period information PT for the first region is described as an example.

In the viewable period information PT for the first region, 2 bytes of information describe a period during which distributed recording information can be reproduced and viewed in the first region. To be specific, from the start of the information, 5 bits of information describe a year up to 2032 (i.e., 2000+25 years) as a starting year of the viewable period in the first region, the subsequent 4 bits of information describe a starting month of the viewable period, the subsequent 5 bits of information describe a length of the viewable period, and the last 1 bit of information describes whether the viewable period is limited or not.

This description format is similarly applied to the viewable period information PT for other regions and the recordable period information RT for each region.

Finally, the time-shiftable period information TT included in the first information tables TB1a and TB1b describes a period during which distributed recording information can be subjected to time-shirt reproduction, that is, a period during which recording information received by the set-top box STB can be subjected to time-shift reproduction with an upper limit of 168 hours (1 week).

Referring to FIGS. 11 and 12, the following will describe the detailed configuration and operations of the set-top box STB for receiving recording information which is transmitted via the communications satellite SR after the information table TBa is superimposed on the recording information. The information table TBa includes the first table TB1a or TB1b having the above configuration and the second information table TB2.

FIG. 11 is a block diagram showing the schematic configuration of the set-top box STB. FIG. 12 is a flowchart showing demodulation in the set-top box STB.

As shown in FIG. 11, the set-top box STB for demodulating recording information can output the digital output signal Sd to the recorder RC and output the image signal Svd and the sound signal Sad to the television set TV. The recording information is received by the antenna ATR via the communications satellite SR and is inputted as the received signal Srr. To be specific, the set-top box STB is constituted of a front end 20, a descrambler 21, demultiplexer 22, a sound decoder 23, an image decoder 24, a CPU 25, a memory 26, an extracting/converting section 27, watermark inserting section 27a, a watermark detecting section 28, an encrypting section 29, and an interface 30. The constituent members can send and receive control information and so on to and from one another via a bus 31. Further, the CPU 25 stores region information indicating countries or regions where the set-top box STB should be installed and operated.

Operations will be discussed below.

First, the following will describe the operations of the set-top box STB when the received signal Srr is outputted as the image signal Svd and the sound signal Sad to the television set TV.

In this case, in the received signal Srr, sound information and image information are compressed according to MPEG in the above-described manner and are inputted while being encrypted.

The front end 20 performs a predetermined receiving operation on the received signal Srr, generates a processed/received signal Sfe, and outputs the signal to the descrambler 21.

Subsequently, the descrambler 21 decrypts the encryption of recording information included in the processed/received signal Sfe, generates a decryption signal Sds, and outputs the signal to the demultiplexer 22.

Thus, the demultiplexer 22 separates sound information and image information included in the decryption signal Sds, outputs the separated sound information to the sound decoder 23 as a separated sound signal Sas, and outputs the separated image information to the image decoder 24 as a separated image signal Svs.

Then, the sound decoder 23 decodes the sound signal Sas and outputs the signal to the television set TV as the sound signal Sad.

Meanwhile, the image decoder 24 decodes the image signal Svs and similarly outputs the signal to the television set TV as the image signal Svd.

At this point, the CPU 25 exercises control over the constituent members while transmitting and receiving necessary control information via the bus 31. The necessary information is used for the control while being stored in the memory 26 via the bus 31 for the time being.

The following will discuss the operations of the set-top box STB when recording information acquired as the received signal Srr is outputted to the recorder RC as the digital output signal Sd.

First, when the digital output signal Sd is outputted to the recorder RC, in response to the received signal Srr inputted to the set-top box STB, the decryption signal Sds is generated by the operations of the front end 20 and the descrambler 21 and is outputted to the extracting section 27 and the watermark detecting section 28.

Hence, the extracting/converting section 27 extracts from the decryption signal Sds only recording information to be recorded on the DVD 100 in the recorder RC, generates an extraction signal Sdv, and outputs the signal to the watermark inserting section 27a. At this point, in the extracting/converting section 27, when the demodulation of the set-top box STB is set beforehand as reproduction having image degradation at the first step or image degradation at the second step, necessary picture quality degradation is performed in parallel with the extraction to generate the extraction signal Sdv.

Then, the watermark inserting section 27a inserts, into the extraction signal Sdv, watermarks to be inserted into image information having been outputted to the recorder RC, generates an insertion/extraction signal Sidv, and outputs the signal to the encrypting section 29.

In parallel with this operation, the water mark detecting section 28 extracts the information table TBa which is superimposed on recording information included in the decryption signal Sds, and outputs the contents to the CPU 25 via the bus 31.

As will be described later in FIG. 12, when recording information is demodulated according to the contents in the information table TBa, the demodulated recording information is temporarily recorded with the information table TBa in an external storage device included in the memory 26 (to be specific, a hard disc and so on). Then, the recording information is read from the external storage device as necessary and is outputted to the encrypting section 29 as an output to the recorder RC.

Thus, the encrypting section 29 encrypts the extraction signal Sdv by using an encryption key which is set in the interface 30 by mutual authentication with the recorder RC, generates an encryption signal SX, and outputs the signal to the interface 30.

Further, the interface 30 performs predetermined interface processing on the encryption signal Sx and outputs the signal to the recorder RC as a digital output signal Sd. In this case, the information table TBa in the recording information included in the received signal Srr is superimposed as it is on the corresponding recording information, and is outputted to the recorder RC.

At this point, the CPU 25 exercises control over the constituent members according to the contents of the information table TBa detected in the watermark detecting section 28 while transmitting and receiving necessary control information via the bus 31. The necessary information is used for the control while being stored in the memory 26 via the bus 31 for the time being.

Referring to the flowchart of FIG. 12, the following will summarize demodulation performed in the set-top box STB configured thus. The following will describe demodulation when recording information acquired as the received signal Srr is outputted to the recorder RC as the digital output signal Sd.

As shown in FIG. 12, in the demodulation of Embodiment 2, identification information ID in the sector information ST is first detected from recording information inputted as the received signal Srr (step S20).

Then, information in the sector information ST reproduced subsequently to the identification information ID is read to confirm whether the information is encrypted or not (step S21). When the information is not encrypted (step S21; NO), the process advances to step S23 (described later). When the information is encrypted (step S21; YES), the encryption is decrypted in the descrambler circuit 21 (step S22) and received recording information is read while the decryption is performed (step S23).

Subsequently, it is monitored all the time whether the reading of necessary information is completed or not during the reading of the recording information (step S24). When the reading is not completed (step S24; NO), the process returns to step S20 to reproduce recording information in the subsequent sector information ST. When the reading of necessary information is completed (step S24; YES), the read recording information (decryption signal Sds) is decoded in the extracting section 27 (step S25) and watermarks WM are detected in the watermark detecting section 28 from information corresponding to the sector information ST included in the decryption signal Sds (step S26).

Then, it is confirmed whether the watermarks WM are detected or not (step S27). When the watermarks WM are not detected (step S27; NO), it is decided that reproduction restriction is not necessary on recording information in the received signal Srr which is currently received, and the process advances to the processing of step S37 (described later). When the watermarks WM are detected (step S27; YES), region information is obtained which is stored in the CPU 25 and corresponds to the set-top box STB (step S28), the contents of the first information table TB1a or TB1b and the second information table TB2 are extracted from the watermarks WM detected in step S26 and are decrypted in the watermark detecting section 28, and the reproducible region information PA and the recordable region information RAA are obtained as stream region information (step S29).

Subsequently, based on the obtained reproducible region information PA, it is confirmed whether recording information in the received signal Srr can be reproduced or not in regions indicated by the region information obtained in step S28, that is, in countries or regions where the set-top box STB should be installed and operated (step S30). Then, when the reproducible region information PA indicates that the installation region of the set-top box STB is not a region where recording information can be reproduced (step S30; NO), the recording information cannot be demodulated by the set-top box STB. Thus, the set-top box STB is reset to forcefully terminate demodulation performed on the received signal Srr (step S32), a warning that the demodulation cannot be performed is issued on a display (not shown) and so on (step S33), and a series of demodulating operations is completed.

When it is decided in step S30 that the reproducible region information PA indicates that the installation region of the set-top box STB is a region where recording information included in the received signal Srr can be reproduced (step S30; YES), confirmation is made on the contents of the copy control information IF in each piece of the sector information ST and the contents of the region copy control information ACCI in the detected (steps S26 and S27) first information table TB1a, and it is confirmed whether or not the contents of the copy control information IF corresponding to a region indicated by the region information match with the contents of the region copy control information ACCI corresponding to the region (that is, whether any one of the information IF and the information ACCI is illegally tampered or not) (step S31).

When the contents of the copy control information IF corresponding to a region indicated by the region information match with the contents of the region copy control information ACCI corresponding to the region (step S31; YES), it is decided that illegal tampering or the like is not performed on recording information in the received signal Srr. Subsequently, it is confirmed whether or not recording information in the received signal Srr can be subjected to time-shift reproduction in a region indicated by the region information obtained in step S28, based on the time-shiftable region information TA obtained in step S29 (step S34). Then, when the time-shiftable region information TA indicates that the installation region of the set-top box STB is not a region where recording information can be subjected to time-shift reproduction (step S34; NO), the process advances to step S37 (described later).

When it is decided in step S34 that the installation region of the set-top box STB is a region where recording information can be subjected to time-shift reproduction (step S34; YES), information indicating the implementation of time-shift reproduction and the detected time-shiftable period information TT are set (step S35). Subsequently it is confirmed whether the currently performed demodulation has any of the picture quality degradation and it is confirmed whether decoded (step S25) recording information includes any one of the first post conversion first copy control information XCI1 and the first post conversion second copy control information XCI2 or the second post conversion first copy control information XXI1 and the second post conversion second copy control information XXI2 (step S36).

When the demodulation has any of the image degradation and includes post conversion copy control information (step S36; YES), the contents of the picture quality degradation and post conversion copy control information corresponding to a region indicated by the region information are set in the watermark inserting section 27a as copy control information to be included in recording information which is outputted as the digital output signal Sd (step S37). Subsequently, the recording information decoded from the received signal Srr with the set time-shiftable period information TT and soon is recoded with the set (step S37) copy control information in the external storage device (to be specific, a hard disc and so on) included in the memory 26 (step S38).

In the decision of step S36, when the demodulation of FIG. 12 does not include any of picture quality degradation or when the decoded (step S25) recording information does not include any one of the post conversion copy control information (step S36; NO), the process advances to the recording (recording not including copy control information) of step S38.

Then, it is confirmed whether the recording of the recording information and so on is completed or not and it is confirmed whether the set-top box STB should be turned off or not (step S39). When it is decided that the set-top box STB should be turned off (step S39; YES), a series of demodulating operations is completed.

On the other hand, when it is decided in step S39 that demodulation is continuously performed (step S39; NO), the process returns to step S20 and the series of processing is repeated.

When it is decided in step S31 that the contents of the copy control information IF corresponding to a region indicated by the region information do not match with the contents of the region copy control information ACCI corresponding to the region (step S31; NO), the recording information in the received signal Srr may be illegally tampered. Therefore, it is decided that the currently received recording information should not be demodulated, the set-top box STB is reset to forcefully terminate the demodulation in the set-top box STB (step S32), a warning that the recording information cannot be demodulated is issued on the display (not shown) and so on (step S33), and a series of demodulating operations is completed.

When the picture quality degradation is not performed in the demodulation of Embodiment 2, the first copy control information CCI1 and the second copy control information CCI1 in the distributed recording information are included as they are in the demodulated recording information.

Finally, referring to FIGS. 13 and 14, the following will describe the detailed configuration and operations of the recorder RC for recording the digital output signal Sd outputted from the set-top box STB on the DVD 100 while the information table TBa is superimposed on the digital signal Sd. The information table TBa includes the first table TB1a or TB1b having the above configuration and the second information table TB2.

FIG. 13 is a block diagram showing the schematic configuration of the recorder RC. FIG. 14 is a flowchart showing the recording in the recorder RC.

As shown in FIG. 13, the recorder RC which records recording information on the recordable DVD 100 is constituted of a pickup 40, a spindle motor 41, a servo control section 42, an LD (LASER Diode) driver 43, a signal processing circuit 44, a scrambler circuit 45, a switch 48, a watermark inserting section 47, an MPEG encoder 49, an A/D (Analog/Digital) converter 50, a descrambling converter circuit 51, communications interface 52, a watermark detecting section 53, a system control section 54, and a DVD formatter 56. The servo control section 42, the signal processing circuit 44, the scrambler circuit 45, the watermark inserting section 47, the descrambler circuit 51, the communications interface 52, the watermark inserting section 53, and the system control section 54 are connected to one another via a bus 55 so that control information and so on can be sent and received to and from one another.

Operation will be described below.

First, recording information outputted from the set-top box STB as the digital output signal Sd is compressed according to a compression method conforming to MPEG and is recorded on the DVD 100. Further, the recording information is encrypted according to a predetermined encryption scheme before compression, and then, the recording information is recorded. Further, the recording information is recorded with the information table TBa embedded (multiplexed) as the watermark WM.

In addition to the recording of the digital output signal Sd on the DVD 100, the recorder RC can digitize analog information (including both of analog sound information and analog image information) from outside and record the information on the DVD 100.

When recording information is recorded on the DVD 100, the DVD 100 is first rotated at a predetermined rotational speed by the spindle motor 41 in the recorder RC. The spindle motor 41 is driven in response to a spindle control signal Ssb (described later).

Then, the A/D converter 50 digitizes the analog information Sai inputted from the outside, generates a digital input signal Sdin, and outputs the signal to the MPEG encoder 49.

Subsequently, the MPEG encoder 49 performs compression on the digital input signal Sdin according to MPEG, generates a compression signal Sme, and outputs the signal to the switch 48.

The interface 52 performs predetermined input interface processing on the digital output signal Sd under the control of the system control section 54 via the bus 55, and outputs the signal to the descrambler circuit 51 as a processing signal Sif.

Then, the descrambler circuit 51 decodes the encryption of the recording information, which is included in the processing signal Sif (that is, recording information which is demodulated and transmitted in the set-top box STB), under the control of the system control section 54 via the bus 55, generates a decoding signal Sdx, and outputs the signal to the switch 48.

At this point, in the descrambling/converting section 51, when it is decided beforehand that picture quality degradation at the first step or picture quality degradation at the second step should be performed with the recording in the recorder RC instead of the demodulation in the set-top box STB, necessary picture quality degradation is performed in parallel with the decoding and the decoding signal Sdx is generated.

Thus, according to a switching signal Sswl from the system control section 54, the switch 48 selects a signal inputted at that time from the decoding signal Sdx and the compression signal Sme, and the switch 48 outputs the signal as a switch signal Spl to the watermark inserting section 47 and the watermark detecting section 53.

Hence, under the control of the system control section 54 via the bus 55, the watermark detecting section 53 detects the information table TBa included in the switch signal Spl and outputs the contents to the system control section 53.

Then, when it is decided that the analog information Sai currently inputted to the recorder RC or the recording information included in the digital output signal Sd are prohibited from being recorded on the DVD 100, the system control section 54 controls the constituent members in such a manner as to suspend the subsequent recording of the analog information Sai or the digital output signal Sd according to the outputted contents of the information table TBa.

Regarding the detailed specific configuration of the watermark detecting section 53, like the watermark detecting section 6, a watermark detecting section configured as disclosed in paragraphs [0035] to[0053] and FIG. 3 of Japanese Patent Laid-Open No. 11-98341 is suitable.

Under the control of the system control section 54 via the bus 55, the watermark inserting section 47 inserts the information table TBa, which has the contents applied to the recording information having been recorded on the DVD 100, into the switch signal Spl, generates an insertion signal Sis, and outputs the signal to the DVD formatter 56.

To be specific, for example, regarding the copy control information CCI in the information table TBa included in the inputted digital output signal Sd, when the contents of the copy control information CCI corresponding to a county or a region where the recorder RC is installed indicate that the corresponding recording information can be recorded only once on the DVD 100 in the region, copy prohibition information for prohibiting the subsequent copying and recording is inserted as copy control information CCI corresponding to the country or region where the recorder RC is installed, in the copy control information CCI in the information table TBa inserted by the watermark inserting section 47.

Then, the DVD formatter 56 converts the insertion signal Sis into a recording format for the DVD 100, generates a format signal Sdvd, and outputs the signal to the scrambler circuit 45.

Hence, under the control of the system control section 54 via the bus 55, the scrambler circuit 45 encrypts recording information included in the format signal Sdvd (including the information table TBa having the contents applied to the recording information having been recorded on the DVD 100) by using the predetermined encryption key, generates an encryption signal Ssx, and outputs the signal to the signal processing circuit 44.

Then, under the control of the system control section 54 via the bus 55, the signal processing circuit 44 performs processing for recording that includes waveform shaping on the encryption signal Ssx, generates a processing signal Sec, and outputs the signal to the LD driver 43.

Subsequently, the LD driver 43 performs processing such as amplification on the processing signal Sec, generates a driving signal Sld for driving a semiconductor laser (semiconductor laser for irradiating the DVD 100 with a light beam B for recording, not shown) in the pickup 40, and outputs the signal to the pickup 40.

Thus, the pickup 40 irradiates the rotating DVD 100 with the light beam B for recording (the light beam B changes in intensity according to the contents of recording information to be recorded) and records recording information, which includes the information table TBa, on the corresponding position on the DVD 100.

At this point, an actuator (not shown) for changing the position of an object lens (not shown) for condensing the light beam B on an information track is driven by a pickup servo signal Ssp which is outputted from the servo control section 42 under the control of the system control section 54 via the bus 55, so that a displacement of the focusing position of the light beam B is eliminated relative to the position of the information track where recording information should be recorded on the DVD 100.

In parallel with the operations of the constituent members, the system control section 54 prevents illegal reproduction and illegal recording in the above manner and exercises control over the operations of the constituent members via the bus 54.

Referring to the flowchart of FIG. 14, the following will summarize recording performed in the recorder RC configured thus. The following will discuss recording performed when the switch 48 is connected to the descrambler circuit 51 and recording information outputted as the digital output signal Sd from the set-top box STB is recorded on the DVD 100.

As shown in FIG. 14, in the recording of Embodiment 2, identification information ID in the sector information ST is first detected from recording information inputted as the digital output signal Sd (step S40).

Then, information in the sector information ST reproduced subsequently to the identification information ID is read to confirm whether the information is encrypted or not (step S41). When the information is not encrypted (step S41; NO), the process advances to step S43. When the information is encrypted (step S41; YES), the encryption is decrypted in the descrambler circuit 51 (step S42) and recording information in the inputted digital output signal Sd is read while being decrypted (step S43).

Subsequently, it is monitored all the time whether the reading of necessary information is completed or not during the reading of the recording information (step S44). When the reading is not completed (step S44; NO), the process returns to step S40 to reproduce recording information in the subsequent sector information ST. When the reading of necessary information is completed (step S44; YES), the read recording information is decoded in the descrambler circuit 51 and so on (step S45) and the watermark detecting section 53 detects watermarks WM from information corresponding to the sector information ST included in the decoding signal Sdx (step S46).

Then, it is confirmed whether the watermarks WM are detected or not (step S47). When the watermarks WM are not detected (step S47; NO), it is decided that recording information in the currently inputted digital output signal Sd is recorded as it is and the process advances to the processing of step S57 (described later). When the watermarks WM are detected (step S47; YES), region information is acquired which is stored in the system control section 54 and corresponds to the recorder RC (step S48), the contents of the first information table TB1a or TB1b and the second information table TB2 are extracted from the watermarks WM detected in step S46 and are decrypted in the watermark detecting section 53, and the reproducible region information PA and the recordable region information RAA are obtained as stream region information (step S49).

Subsequently, based on the obtained recordable region information RAA, it is confirmed whether recording information in the digital output signal Sd can be recorded or not in regions indicated by the region information obtained in step S48, that is, in countries or regions where the recorder RC should be installed and operated (step S50). Then, when the recordable region information RAA indicates that the installation region of the recorder RC is not a region where recording information can be reproduced (step S50; NO), the recording information cannot be recorded on the DVD 100 by the recorder RC. Thus, the recorder RC is reset to forcefully terminate the recording (step S52), a warning that the recording cannot be performed is issued on a display (not shown) and so on (step S53), and a series of recording operations is completed.

When it is decided in step S50 that the recordable region information RAA indicates that the installation region of the recorder RC is a region where recording information included in the digital output signal Sd can be recorded (step S50; YES), confirmation is made on the contents of the copy control information CCI corresponding to a country or region where the recorder RC is installed, in the copy control information CCI in the first information table TB1a or TB1b detected from the digital output signal Sd (step S51).

Then, when the copy control information CCI decided in step S51 has the contents of copy prohibition information for prohibiting the subsequent copying and recording of the recording information or the contents of copy prohibition information indicating that the corresponding recording information is originally prohibited strictly from being copied or recorded (step S51; NO), it is decided that recording information in the digital output signal Sd should not be recorded on the DVD 100, the recorder RC is reset to forcefully terminate the recording of the recorder RC (step S52), and a warning that the recording information cannot be recorded is issued on the display (not shown) and so on (step S53), and a series of demodulating operations is completed.

When the contents of the copy control information CCI decided in step S51 indicate that the corresponding recording information can be recorded on the DVD 100 only once in the region or indicate that the copying of the corresponding recording information is not restricted in the region (step S51; YES), it is confirmed whether or not the copy control information CCI decided in step S51 has contents indicating that the copying of the corresponding recording information is not restricted in the region (step S54).

Then, when it is decided in step S54 that the contents of the copy control information CCI indicate that the copying of the corresponding information is not restricted in the region (step S54; YES), the process advances to step S57 (described later) to start recording the recording information on the DVD 100.

When the contents of the copy control information CCI do not indicate that the copying of the corresponding recording information is not restricted in the region (step S54; NO), it is confirmed again whether the contents of the copy control information CCI decided in step S51 indicate that the corresponding recording information can be copied and recorded only once on the DVD 100 in the region (step S55). When the recording information can be copied and recorded more than once, that is, when the recording information can be copied and recorded two or more times (step S55; NO), the process advances to step S57 (described later) to start recording the recording information on the DVD 100.

Further, when the contents of the copy control information CCI decided in step S51 indicate that the corresponding recording information can be copied and recorded only once on the DVD 100 in the region (step S55; YES), information in the information table TBa is rewritten (step S56), and the process advances to step S57 (described later).

The processing of step S56 will be discussed in detail. In the processing of step S56, first, when recording is permitted in the decision of step S54, the first information table TB1b and the second information table TB2 are superimposed for the information table TBa superimposed on the corresponding recording information. In this case, of the recording region information RA in the first information table TB1b, the recording region information RA is set at “1b” which corresponds to a country or region where the recorder RC is installed is set at “1b”.

Second, only when recording information permitted to be recorded (step S51; YES) can be copied and recorded only once in a country or region where the recorder RC is installed, the contents of the copy control information CCI corresponding to the country or region where the recorder RC is installed is rewritten from “copying and recording can be performed only once” to “subsequent copying and recording are prohibited”, of the copy control information CCI in the corresponding first information table TB1b.

Moreover, thirdly, in order to specify a country or region where reproduction can be performed on the recording information having been recorded on the DVD 100 by the recorder RC, the values of the corresponding region reproducible region information PA1 to PA8 are rewritten, which are included in the reproducible region information PA in the first information table TB1b, by using values corresponding to the region recordable/reproducible region information RP1 to RP8 which are included in the post recording reproducible region information RP (FIG. 2(c)) in the second information table TB2.

When the rewriting of the contents of the information table TBa is completed, the copy control information IF in the sector information ST is set after recording by using the contents of the copy control information CCI included in the rewritten information table TBa (step S57).

Subsequently, it is confirmed whether the currently performed recording has any of the picture quality degradation and it is confirmed whether decoded (step S45) recording information includes any one of the first post conversion first copy control information XCI1 and the first post conversion second copy control information XCI2 or the second post conversion first copy control information XXI1 and the second post conversion second copy control information XXI2 (step S58).

When the recording has any of the picture quality degradation and includes the post conversion copy control information (step S58; YES), the contents of the picture quality degradation and the post conversion copy control information corresponding to a region indicated by the region information are set as copy control information to be included in recording information outputted as the insertion signal Sis (step S59) and recording information is recorded on the DVD 100 (step S60) while including the information set until then (steps S56, S57, and S59).

When it is decided in step S58 that the recording of FIG. 14 does not include any of the picture quality degradation or the decoded (step S45) recording information does not include any one of the post conversion copy control information (step S58; NO), the process advances to the recording of step S60 (recording not including the copy control information).

Then, it is confirmed whether recording information is completely recorded or not on the DVD 100 (step S61). When the recording is not completed (step S61; NO), the process returns to the processing of step S40 and recording information to be subsequently recorded is recorded. When recording information to be recorded is completely recorded (step S61; YES), a series of recording operations is terminated.

When picture quality is not degraded in the recording of Embodiment 2, the first copy control information CCI1 and the second copy control information CCI1 in recording information demodulated in the set-top box STB are included as they are in the recording information having been recorded on the DVD 100.

The operations of the DVD player P included in the information transmission system SS of Embodiment 2 are completely the same as the DVD player P of Embodiment 1 in that recording information recorded on the DVD 100 by the recorder RC is reproduced while reproduction is restricted according to the information table TBa superimposed on the recording information (however, any of the picture quality degradation is not performed). Thus, the detailed explanation is omitted.

As described above, according to the operations of the information transmitter M, the set-top box STB, the recorder RC, and the DVD player P of Embodiment 2, distributed recording information includes the first post conversion first copy control information XCI1 and the first post conversion second copy control information XCI2 or the second post conversion first copy control information XXI1 and the second post conversion second copy control information XXI2, and the first copy control information CCI1 and the second copy control information CCI2. When picture quality and so on are degraded during the demodulation of recording information in the set-top box STB or during recording in the recorder RC, post conversion copy control information corresponding to a degradation in the picture quality and so on is superimposed on the demodulated or recorded recording information. When picture quality and so on are maintained during the demodulation or recording of the recording information, the first copy control information CCI1 and the second copy control information CCI2 are superimposed on the recording information during demodulation or after recording, and then, the information is outputted. Thus, it is possible to change the contents of copying restriction according to a change in picture quality and so on during demodulation or recording, thereby effectively protecting the copyright of the recording information.

Further, when the picture quality and so on of recording information are degraded and demodulation or recording is performed, post conversion copy control information is superimposed with more moderate restrictive conditions of copying. Thus, in the case of recording information degraded in picture quality and so on during demodulation or recording, copying is restricted under moderate restrictive conditions of copying. In the case of recording information not being degraded in picture quality and so on during demodulation or recording, copying can be restricted by the original first copy control information CCI1 and second copy control information CCI2. Hence, the restrictive conditions of copying can be made moderate or strict according to the quality of recording information, so that it is possible to widely distribute recording information while adjusting interests between the creator and the user of the recording information and it is possible to widely and properly restrict the copying of the recording information, thereby effectively protect the copyright of the recording information.

### (III) Embodiment 3

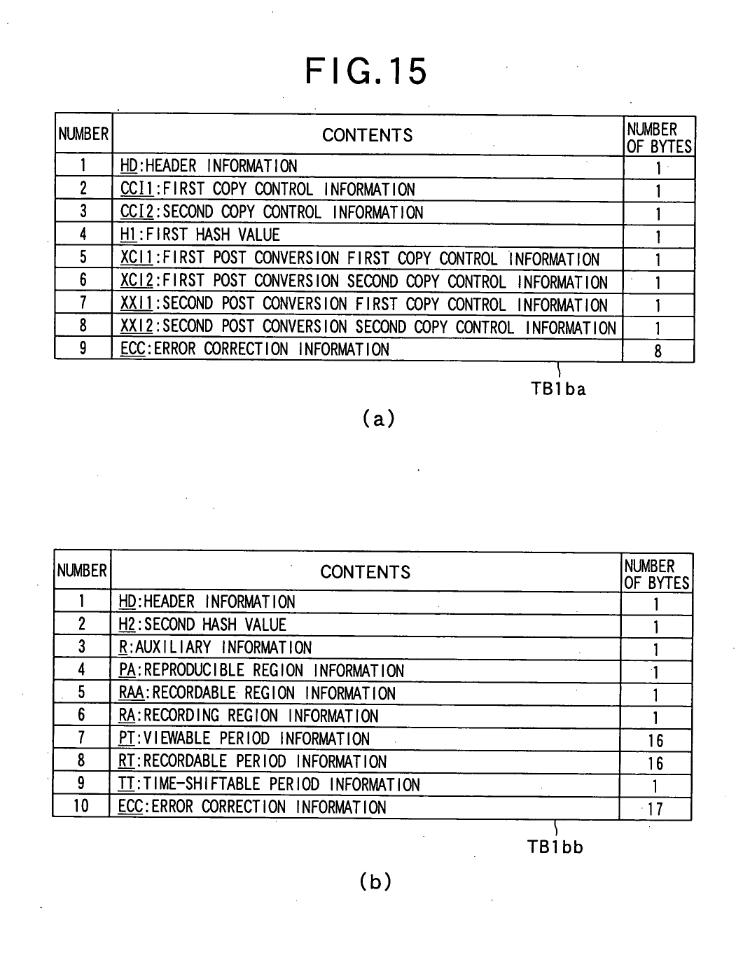

Referring to FIG. 15, the following will describe Embodiment 3 which is another embodiment of the present invention. FIG. 15 is a diagram showing the detailed configuration of an information table according to Embodiment 3.

In Embodiment 1 and Embodiment 2, the information table TB or TBa includes the first information table TB1 and the second information table TB2 (in case of Embodiment 1) and the first information table TB1a or TB1b and the second information table TB2 (in case of Embodiment 2). In Embodiment 3 described below, a first information table TB1 (TB1a or TB1b) is divided into two with correlation for preventing tampering and is superimposed in recording information. Embodiment 3 is discussed below with an example where the first information table TB1b of Embodiment 2 is divided.

The configuration and operations of an information transmission system according to Embodiment 3 are completely the same as those of the information transmission system SS according to Embodiment 2 except for the format of the used information table. Thus, the detailed explanation thereof is omitted.

Of information tables used in the information transmission system of Embodiment 3, a first information table is embedded in sector information ST as a watermark WM while being divided into a sub information table TB1ba and a sub information table TB1bb as shown in FIG. 15.

As shown in FIG. 15(a), the sub information table TB1ba includes, from the first byte, header information HD (1 byte) which is similar to that of the first information table TB1b, first copy control information CCI1 (1 byte), second copy control information CCI2 (1 byte), first post conversion first copy control information XCI1 (1 byte), first post conversion second copy control information XCI2 (1 byte), second post conversion first copy control information XXI1 (1 byte), and second post conversion second copy control information XXI2 (1 byte). In addition, the sub information table TB1ba includes a first hash value H1 (1 byte) which is a hash value obtained by converting the contents of the sub information table TB1bb by using a predetermined hash function when bit values (a second hash value H2 described later) included in the second byte of the sub information table TB1bb (described later) are all set at “0”, and includes error correction information ECC (8 bytes) used for error correction when the sub information table TB1ba is detected during the distribution or recording of recording information.

As shown in FIG. 15(b), the sub information table TB1bb includes, from the first byte, header information HD (1 byte) indicating that the subsequent information is included in the sub information table TB1bb, a second hash value H2 (1 byte) having the contents described later, auxiliary information R describing no significant information, reproducible region information PA (1 byte) similar to that of the first information table TB1b, recordable region information RAA (1 byte), recording region information RA (1 byte), viewable period information PT (16 bytes), recordable period information RT (16 bytes), time-shiftable period information (1 byte) TT, and error correction information ECC.

At this point, a hash value obtained by converting the sub information table TB1ba by using the hash function is described as the second hash value H2. When the first hash values H1 included in the first sub information table TB1ba are all “0”, it is not possible to correctly prevent tampering by using the hash values. Thus, the auxiliary information R is set at a proper value to prevent all the first hash values H1 from being set at “0”.

According to Embodiment 3 where the first information table is constituted of the sub information tables TB1ba and TB1bb configured thus, for example, during demodulation in the set-top box STB, the contents of the sub information table TB1ba are first recognized in a CPU 25. Subsequently, when the first hash values H1 included the sub information table TB1ba are not “0”, it is recognized in a set-top box STB that the sub information table TB1bb is present in addition to the sub information table TB1ba, and then, the sub information table TB1bb is detected. At this point, when the detected sub information table TB1bb is illegally tampered, the contents of a first hash value H1 obtained by converting the contents of the tampered sub information table TB1bb by using the hash function are different from the contents of the first hash value H1 to be included in the sub information table TB1ba (that is, a first hash value H1 corresponding to the sub information table TB1bb not being tampered). Hence, it is possible to detect in the CPU 25 whether the contents are tampered or not when the sub information table TB1bb is detected.

On the other hand, when the previously detected sub information table TB1ba is illegally tampered, the contents of a second hash value H2, which is obtained by converting the contents of the tampered sub information table TB1ba by using the hash function, are different from the contents of a second hash value H2 to be included in the sub information table TB1bb (that is, a second hash value H2 corresponding to the sub information table TB1ba not being tampered) Hence, it is possible to recognize whether the previously detected sub information table TB1ba is tampered or not when the sub information table TB1bb is detected.

When tampering is detected on the sub information table TB1ba or TB1bb, demodulation on recording information in the set-top box STB is forcefully terminated at that point, thereby preventing demodulation on illegally tampered recording information.

Further, also during recording in the recorder RC, it is similarly detected in a system control section 54 whether the sub information table TB1ba or TB1bb is tampered or not, thereby preventing illegal recording on a DVD 100.

Furthermore, also during reproduction in a DVD player P, it is similarly detected in a system control section 7 whether the sub information table TB1ba or TB1bb is tampered or not, thereby preventing illegal reproduction from the DVD 100.

As described above, according to the format of the first information table of Embodiment 3, in addition to the effect obtained by the operations of the information transmission system SS described in Embodiment 2, stream region information and copy control information CCI that correspond to a piece of recording information are superimposed on the recording information separately as the sub information tables TB1ba and TB1bb so as to have a correlation using the predetermined has value between the stream region information and the copy control information CCI. Hence, even when only the recording information is illegally tampered (that is, the correlation is changed) after being distributed, it is possible to positively detect the illegal tampering and it is possible to manage and control, for each region, permission of copying and permission to record or reproduce the recording information after the copying, thereby effectively protecting the copyright of the recording information.

### (IV) Embodiment 4

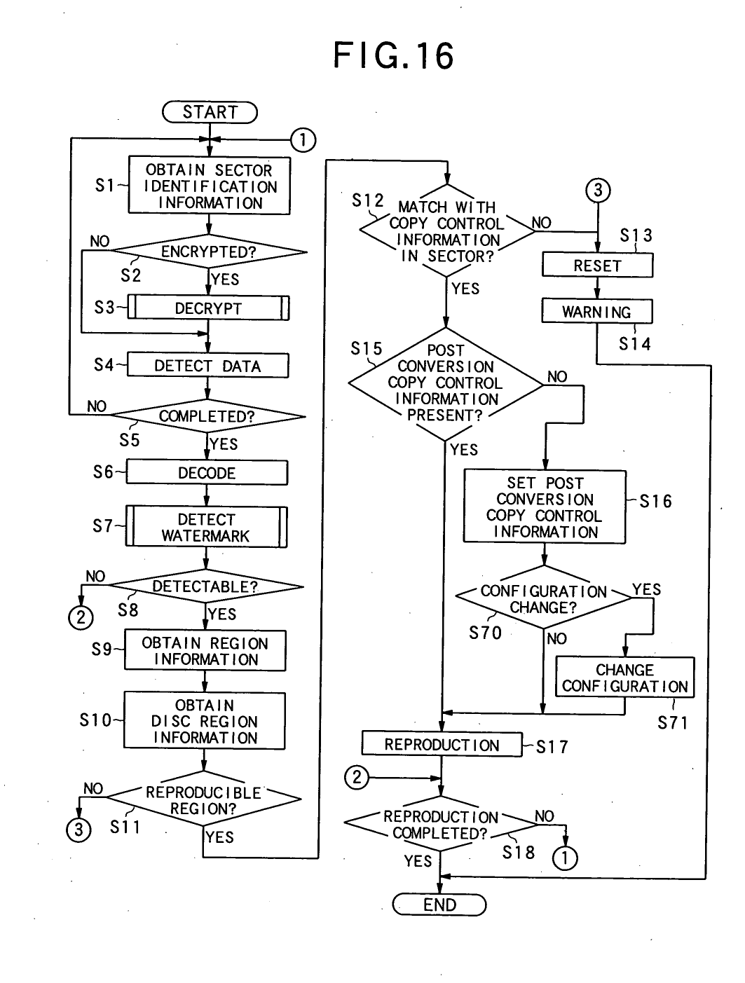

Referring to FIG. 16, the following will describe Embodiment 4, which is another embodiment of the present invention.

FIG. 16 is a flowchart showing information reproduction of Embodiment 4. In the flowchart of FIG. 16, the same processing as the flowchart of FIG. 6 is indicated by the same step number and the detailed explanation thereof is omitted.

In Embodiments 1 to 3, when any of the picture quality degradation is performed during any one of the reproduction, demodulation, and recording of recording information, post conversion copy control information is superimposed on recording information so as to have moderate restrictive conditions of copying according to a pattern of the picture quality degradation and for each region, and the recording is performed. In Embodiment 4 below, the present invention is not applied to a degradation of picture quality and so on but to a change in the configuration of image information included in recording information.

In the following explanation, “a change in the configuration” of image information specifically means that an image included in the image information is scaled up or down and another image information, e.g., advertisement information corresponding to the contents of an advertisement to be directed to the user is superimposed on the image information.

Further, Embodiment 4 will be discussed below by using the information reproduction of Embodiment 1 as an example.

Regarding post conversion copy control information superimposed on recording information in Embodiment 4, when image information included in the recording information is scaled up or down, restrictive conditions of copying are set moderate for recording information which includes the image information having been scaled up or down, as compared with restrictive conditions of copying for recording information which includes image information not being scaled up or down.

To be specific, when “copy prohibited” is indicated by the restrictive conditions of copying for recording information which includes image information having not being scaled up or down, the post conversion copy control information is superimposed beforehand on recording information recorded on a DVD 1 or recording information distributed by an information transmission system SS so that “copy permitted only once” or “copy permitted” is indicated by the restrictive conditions of copying for the recording information which includes image information having been scaled up or down.

When advertisement information is superimposed on image information included in the recording information, restrictive conditions of copying are set moderate for a part of recording information including image information with superimposed advertisement information, as compared with restrictive conditions of copying for recording information including image information with no superimposition.

To be specific, when “copy prohibited” is indicated by the restrictive conditions of copying for recording information including image information with superimposition, the post conversion copy control information is superimposed beforehand on recording information recorded on the DVD 1 or recording information distributed by the information transmission system SS so that “copy permitted” is indicated by the restrictive conditions of copying for the recording information including image information with superimposition.

At this point, a specific method of superimposition is the same as Embodiments 1 to 3 and thus the detailed explanation thereof is omitted.

As shown in FIG. 16, in the information reproduction of Embodiment 4, steps S1 to S16 of the information production of Embodiment 1 are performed first, which are shown in FIG. 6. At this point, post conversion copy control information set in the processing of step S16 includes copy control information, which includes restrictive conditions of copying for the image information having been scaled up or down or the advertisement information having superimposition.

When the corresponding post conversion copy control information is superimposed in the processing of step S16, it is confirmed whether scaling or the superimposition of the advertisement information should be performed or not (step S70). When the processing is actually performed (step S70; YES), necessary scaling or the superimposition of the advertisement information is performed (step S71) and then the process advances to step S17 to perform the same processing as the information reproduction of Embodiment 1.

When it is decided in step S70 that scaling or the superimposition of the advertisement information is not performed (step S70; NO) the process advances to step S17 without changing the contents of copy control information, and the same processing is performed as the information reproduction of Embodiment 1.

As described above, according to the information reproduction of Embodiment 4, in addition to the effect of the information reproduction of Embodiment 1, it is possible to reproduce and output recording information after changing restriction conditions for copying when an image is scaled up or down during reproduction, thereby restricting copying with a wider scope of application.

Further, even when an image is scaled up or down during reproduction and another image is superimposed on the image having been scaled up or down, it is possible to reproduce and output recording information after changing restrictive conditions for copying, thereby restricting copying with a wider scope of application.

Moreover, when the advertisement information is superimposed during reproduction, copying is freely performed on a part of recording information having the superimposed advertisement information. Thus, it is possible to reproduce recording information while restricting the copying of recording information and widely distributing advertisement information.

### (V) Embodiment 5

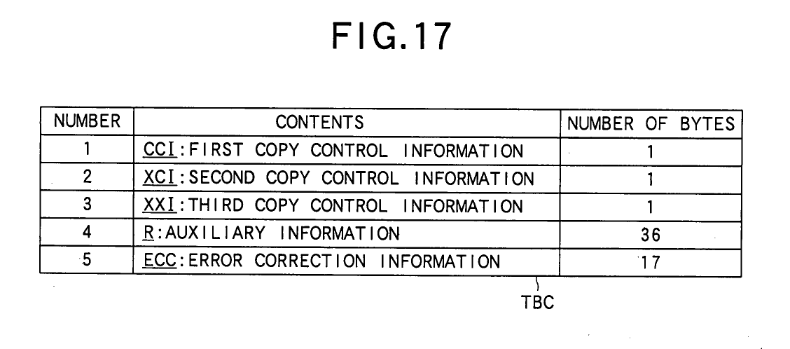

Referring to FIGS. 17 to 19, the following will describe Embodiment 5 which is another embodiment of the present invention.

Embodiments 1 to 4 discussed a combination of region information and copy control information. Embodiment 5 below will discuss the case where recording information including only the copy control information of the present invention is recorded on the DVD.

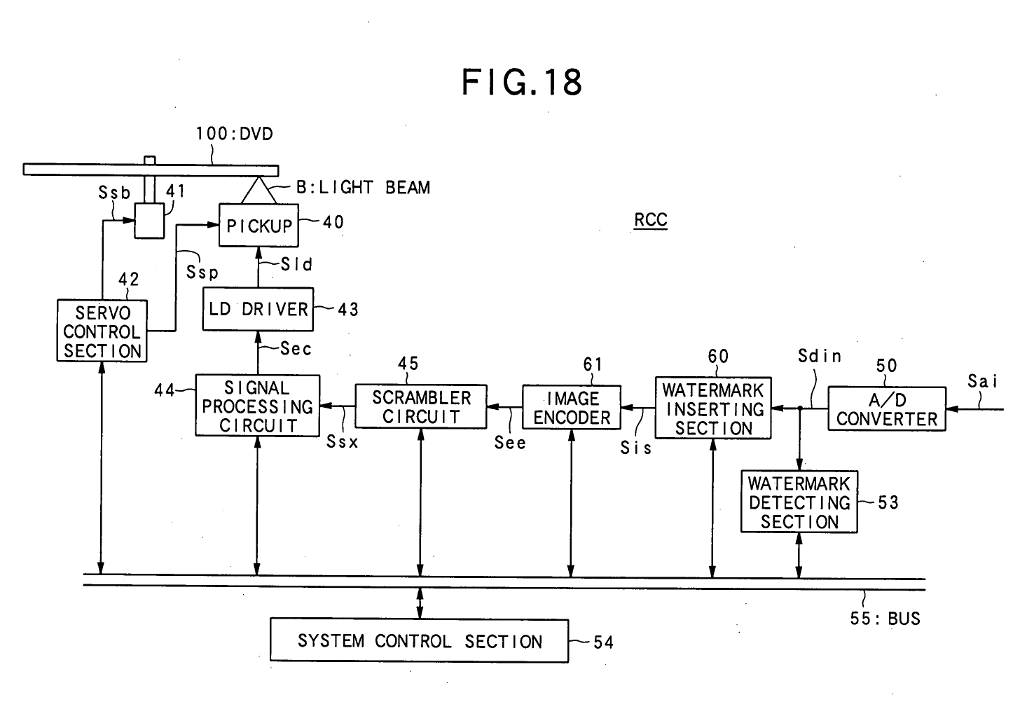

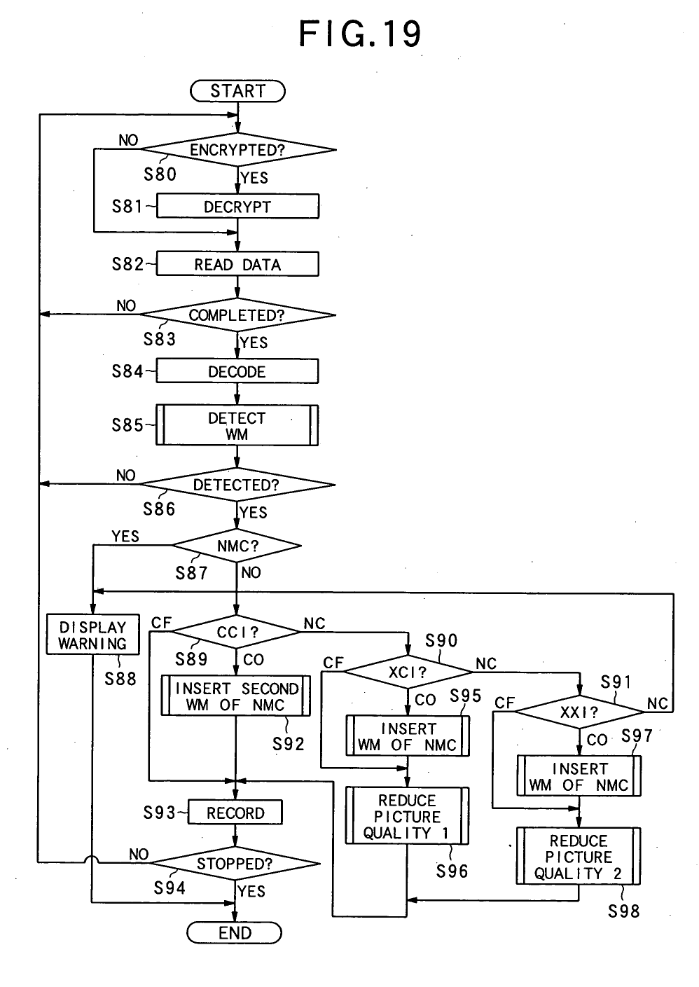

FIG. 17 is a diagram showing the specific contents of information recorded on the DVD. FIG. 18 is a block diagram showing the schematic configuration of an information recording apparatus (DVD recorder) which records recording information on the DVD according to Embodiment 5. FIG. 19 is a flowchart showing a recording operation performed in the DVD recorder.

Referring to FIG. 17, the following will first describe a recording format of information recorded on a playback only DVD according to Embodiment 5.

First, regarding overall recording information on the DVD of Embodiment 5, a physical recording format is the same as Embodiment 1 shown in FIG. 1 and thus the detailed explanation thereof is omitted.

Referring to FIG. 17, the following will specifically discuss the contents of an information table according to Embodiment 5 that is included in each piece of sector information ST in recording information according to Embodiment 5.

As shown in FIG. 17, the information table TBc includes, from the first byte, first copy control information CCI (1 byte) which is copy control information used for recorded recording information when an image included in recording information to be recorded on the DVD is recorded on the DVD without degradation, second copy control information XCI (1 byte) which is copy control information used for recorded recording information when an image included in recording information to be recorded on the DVD is subjected to picture quality degradation at a first step before being recorded on the DVD, third copy control information XXI (1 byte) which is copy control information used for recorded recording information when an image included in recording information to be recorded on the DVD is subjected to picture quality degradation at the second step before being recorded on the DVD, auxiliary information R (36 bytes) including no significant information, and error correction information ECC (17 bytes) used for error correction when the information table TBc is detected during the recording of recording information.

The following will discuss specific values of the copy control information of FIG. 17. In the case where the image is recorded on the DVD without picture quality degradation, when the image is subjected to the picture quality degradation at the first step before being recorded on the DVD, or when the image is subjected to picture quality degradation at the second step before being recorded on the DVD, total prohibition on copying after recording causes the first copy control information CCI, the second copy control information XCI, and the third copy control information XXI to have a value of “copy prohibited.” In the picture quality control (including no degradation of picture quality), when copying can be performed only once after recording, the first copy control information CCI, the second copy control information XCI, and the third copy control information XXI have a value of “copy permitted only once.” Further, in the picture quality control (including no degradation of picture quality), when copying can be freely performed after recording, the first copy control information CCI, the second copy control information XCI, and the third copy control information XXI have a value of “copy permitted”.

Referring to FIGS. 18 and 19, the following will describe the configuration and operations of the recorder which records recording information on the DVD according to Embodiment 5. The recording information is inputted with the superimposed information table TBc having the format of FIG. 17.

In FIG. 18, the same constituent members as the recorder RC (FIG. 13) of Embodiment 2 are indicated by the same reference numerals and the detailed explanation thereof is omitted.

As shown in FIG. 18, a recorder RCC of Embodiment 5 is constituted of an A/D converter 50 similar in configuration to that of the recorder RC described in Embodiment 2, a watermark detecting section 53, a system control section 54 serving as changing means and selecting means, a scrambler circuit 45, a signal processing circuit 44, an LD driver 43, a servo control section 42, a pickup 40 serving as recording means, and a spindle motor 41. In addition, the recorder RCC is constituted of a watermark inserting section 60 and an image encoder 61.

Operations will be discussed below.

When recording information, which is inputted with the superimposed information table TBc having the format of FIG. 17, is recorded on a DVD 100, the DVD 100 is first rotated at a predetermined rotational speed by the spindle motor 41 in the recorder RCC. The spindle motor 41 is driven in response to a spindle control signal Ssb.

Then, the A/D converter 50 digitizes analog information Sai inputted from the outside as the recording information, generates a digital input signal Sdin, and outputs the signal to the watermark inserting section 60 and the watermark detecting section 53.

Hence, under the control of the system control section 54 via a bus 55, the watermark detecting section 53 detects the information table TBc included in the digital input signal Sdin and outputs the contents to the system control section 53.

Under the control of the system control section 54 via the bus 55, the watermark inserting section 60 inserts copy control information, which has the contents applied to the recording information having been recorded on the DVD 100, into the digital input signal Sdin as a watermark, generates an insertion signal Sis, and outputs the signal to the picture quality encoder 61.

Then, the picture quality encoder 61 performs compression on the insertion signal Sis according to MPEG just like the MPEG encoder 49, performs-picture quality degradation according to the contents of the information table TBc detected by the watermark detecting section 53, and outputs the signal to the scrambler circuit 45 as a processing signal See.

Subsequently, under the control of the system control section 54 via the bus 55, the scrambler circuit 45 encrypts recording information included in the processing signal See (including the information table TBc having the contents applied to the recording information having been recorded on the DVD 100) by using a predetermined encryption key, generates an encryption signal Ssx, and outputs the signal to the signal processing circuit 44.

Thereafter, with the same operations as the signal processing circuit 44, the LD driver 43, the pickup 40, and the servo control section 42 in the recorder RC of Embodiment 2, the encrypted recording information is recorded on the DVD 100.

In parallel with the operations of the constituent members, the system control section 54 exercises control over the operations of the constituent members via the bus 55.

Referring to FIG. 19, the following will summarize information recording performed in the recorder RCC of Embodiment 5.

As shown in FIG. 19, in the information recording of Embodiment 5, when the analog information Sai including the information table TBc is inputted from the outside, it is first confirmed whether the analog information Sai is encrypted or not (step S80). When the information is not encrypted (step S80; NO), the process advances to step S82. When the information is encrypted (step S80; YES) the encryption is decrypted (step S81) in a decrypting section (not shown in FIG. 18), and the decrypted recording information is captured (step S82).

Then, it is confirmed whether the capturing is completed or not (step S83). When the capturing is not completed (step S83; NO), the series of capturing operations is continued. When the capturing is completed (step S83; YES), the captured recording information is decoded (step S84) by a decoder (not shown in FIG. 18), the contents of the information table TBc are decrypted in the watermark detecting section 53 (step S85), and the contents are outputted to the system control section 54.

Subsequently, it is confirmed whether a watermark is normally detected or not (step S86). When a watermark is not detected (step S86; NO), the process advances to step S80 to perform decryption again. When a watermark is normally detected, (step S86; YES), it is confirmed whether “copy prohibited” is indicated or not by the contents of another copy control information which is encrypted and inserted in addition to the information table TBc, out of detected watermarks (step S87).

When the contents of another copy control information indicates “copy prohibited” (step S87; YES), it is decided that recording cannot be performed soon on the DVD 100, and the user is notified of the decision on a display. (not shown) (step S88). Thereafter, the recording of Embodiment 5 is completed. Then, the recording of Embodiment 5 is completed.

On the otherhand, when it is decided in step S87 that the contents of another copy control information does not indicate “copy prohibited” (step S87; NO), the contents of the first copy control information CCI in the information table TBc are confirmed (step S89).

When it is decided that copying can be performed without picture quality degradation (step S89; CF), the process advances to the processing of step S93. In the case of “copy permitted only once” without picture quality degradation (step S89; CO), the watermark inserting section 60 inserts another watermark indicating “copy prohibited” (step S92). Thereafter, recording is performed by the image encoder 61 and so on without picture quality degradation (step S93).

Then, it is confirmed whether an operation for indicating the stop of recording is performed by an operation section or not (not shown in FIG. 18) (step S94). When the operation is not performed, the process returns to step S80 to continue to record recording information on the DVD 100. When an instruction is provided to stop recording (stepS94; YES), the recording of Embodiment 5 is completed.

When it is decided in step S89 that copying without picture quality degradation is prohibited (step S89; NC), the contents of the second copy control information XCI in the information table TBc are confirmed (step S90).

When it is decided that copying can be performed after the first picture quality degradation (step S90; CF), the process advances to the processing of step S96. In the case of “copy permitted only once” after the first picture quality degradation (step S90; CO) the watermark inserting section 60 inserts another watermark indicating “copy prohibited” (step S95). Thereafter, the image encoder 61 performs the first picture quality degradation (step S96) and the process advances to the processing of step S93 and later.

When it is decided in step S90 that copying is prohibited after the first picture quality degradation (step S90; NC), the contents of the third copy control information XXI in the information table TBc are confirmed (step S91).

When it is decided that copying can be performed after the second picture quality degradation (step S91; CF), the process advances to the processing of step S98. In the case of “copy permitted only once” after the second picture quality degradation (step S91; CO), the watermark inserting section 60 inserts another watermark indicating “copy prohibited” (step S97). Thereafter, the second picture quality degradation is performed by the image encoder 61 (step S98) and the process advances to the processing of step S93 and later.

On the other hand, when it is decided in step S91 that copying is prohibited even after the second picture quality degradation (step S91; NC), recording cannot be performed on the DVD 100 in any case. Thus, the warning of step S88 is issued and the recording of Embodiment 5 is completed.

As described above, according to the operations of the recorder RCC of Embodiment 5, recording information is recorded on the DVD 100 while picture quality is controlled according to the contents of the information table TBc inputted from the outside. Thus, it is possible to record the recording information on the DVD 100 with some kind of picture quality while protecting copyright corresponding to the recording information by controlling picture quality.

### (VI) Embodiment 6

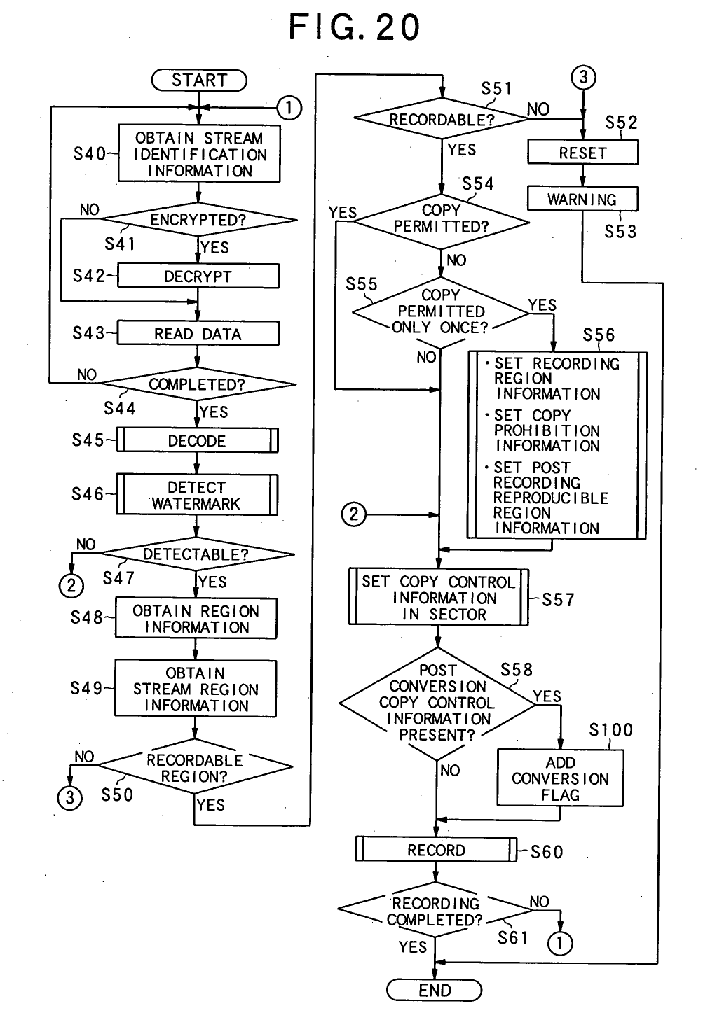

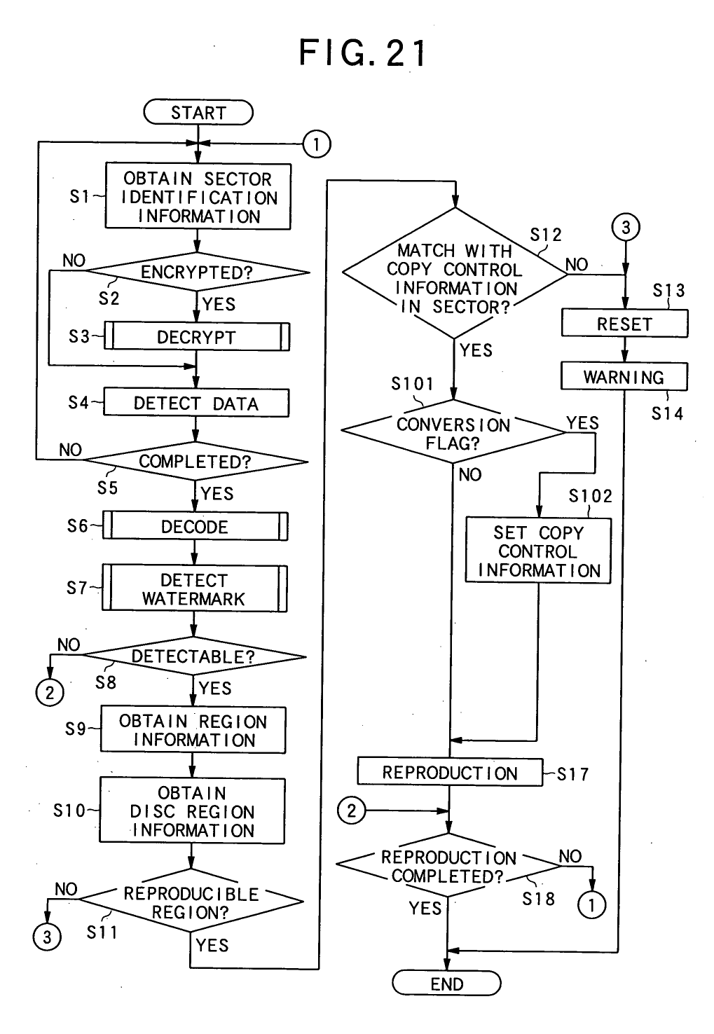

Referring to FIGS. 20 and 21, the following will describe Embodiment 6 which is another embodiment of the present invention.

In Embodiment 6 below, the present invention is applied to the functions of a recorder and a DVD player which are included in an information transmission system similar to the information transmission system SS (the information transmission system SS constituted of a video transmitter M, a transmitter TX, antennas ATT and ATR, a communications satellite SR, a set-top box STB, a television set TV, a recorder RC, and a DVD player P) of Embodiment 2. Since the recorder and the DVD player of Embodiment 6 are similar in configuration to the recorder RC and the DVD player P, the detailed explanation thereof is omitted. The following will discuss only the operations (processing) of the recorder and the DVD player according to the flowcharts shown in FIGS. 20 and 21. FIG. 20 is a flowchart showing the recording performed in the recorder of Embodiment 6. The same processing as recording in the recorder RC of Embodiment 2 shown in FIG. 14 is indicated by the same step number and the detailed explanation thereof is omitted. FIG. 21 is a flowchart showing reproduction in the DVD player of Embodiment 6. The same processing as reproduction in the DVD player P of Embodiment 2 (1) shown in FIG. 6 is indicated by the same step number and the detailed explanation thereof is omitted.

In the foregoing embodiments, for example, when picture quality and so on are changed in the recorder RC in Embodiment 2, copy control information or the like is changed in the recorder RC and is recorded on a DVD with recording information changed in picture quality and soon. In the DVD player P for reproducing the recording information, a reproduction format of the recording information is controlled by using the copy control information or the like recorded with the recording information. In contrast to Embodiment 2, according to Embodiment 6 described below, when picture quality and so on are changed in recording information, a conversion flag serving as change information is added to the recording information in the recorder. The change information indicates a change in picture quality and so on. In the DVD player, copy control information is changed according to the contents of the added flag and is reproduced with the recording information.

Referring to FIG. 20, the following will first describe specific processing of recording performed by the recorder of Embodiment 6.

As shown in FIG. 20, in the recording of the recorder according to Embodiment 6, the processing of steps S40 to S57 is first performed as in the case of the recorder RC of Embodiment 2.

Subsequently, it is confirmed whether the currently performed recording has any of the picture quality degradation and it is confirmed whether decoded (stepS45) recording information includes any one of the first post conversion first copy control information XCI1 and the first post conversion second copy control information XCI2 or the second post conversion first copy control information XXI1 and the second post conversion second copy control information XXI2 (step S58).

When the recording has any of the picture quality degradation and includes post conversion copy control information (step S58; YES), a conversion flag is added to recording information to be recorded on the DVD (step S100), the conversion flag indicating any of the picture quality degradation and the contents of the picture quality degradation (that is, whether picture quality degradation at the first step or picture quality degradation at the second step). Then, the recording information is recorded on the DVD 100 while including the information set (added) until then (steps S56, S57, and S100) (step S60).

When it is decided in step S58 that the recording of FIG. 14 does not include any of the picture quality degradation or the decoded (step S45) recording information does not include any one of the post conversion copy control information (step S58; NO), the process advances to the recording of step S60 (recording not including the copy control information).

Then, it is confirmed whether recording information is completely recorded or not on the DVD 100 (step S61). When the recording is not completed (step S61; NO), the process returns to the processing of step S40 to record recording information to be subsequently recorded. When recording information to be recorded is completely recorded (step S61; YES), a series of recording operations is completed.

When picture quality is not degraded in the recording of Embodiment 2, the first copy control information CCI1 and the second copy control information CCI1 in recording information demodulated in the set-top box STB are included as they are in the recording information having been recorded on the DVD 100.

Referring to FIG. 21, the following will describe reproduction in the DVD player according to Embodiment 6. The DVD player reproduces information from the DVD 100 where recording information and so on are recorded by the recorder.

As shown in FIG. 21, in the reproduction in the DVD player according to Embodiment 6, the processing of steps S1 to S14 is performed, which are similar to those of the DVD player P in Embodiment 2(1).

Subsequently, when it is decided in step S12 that the contents of the copy control information IF corresponding to a region indicated by region information match with the contents of the region copy control information ACCI corresponding to the region (step S12; YES), it is confirmed whether recording information has the conversion flag or not (step S101). When the recording information has the conversion flag (step S101; YES), picture quality degradation is performed on reproduced recording information before reproduction. Thus, the contents of the picture degradation recognized from the contents of the conversion flag and the post conversion copy control information corresponding to the region indicated by the region information (that is, any one of the first post conversion first copy control information XCI1 and the first post conversion second copy control information XCI2 or the second post conversion first copy control information XXI1 and the second post conversion second copy control information XXI2) are set by a watermark inserting section 16a and an adder circuit 17a as copy control information to be included in recording information outputted as an analog output signal Sao (step S102). Subsequently, reproduction is performed to output the decoded (step S6) recording information as the analog output signal Sao (step S17).

When it is decided in step S101 that the decoded (step S6) recording information does not include any conversion flags (step S101; NO), the process advances to the reproduction (reproduction not including post conversion copy control information) of step S17.

Subsequently, the processing of step S18 is performed, which is similar to that of Embodiment 2(1), and the reproduction is completed.

When picture quality degradation is not performed during reproduction in Embodiment 6, the first copy control information CCI1 and the second copy control information CCI1 having been recorded in the DVD 100 are included as they are in the reproduced recording information.

As described above, according to the processing of the recorder and the DVD player in Embodiment 6, when picture quality and so on are degraded (or are not degraded) during the recording of distributed recording information in the recorder RC, the conversion flag having the contents corresponding to the presence or absence of the picture quality degradation and so on is superimposed on the recorded recording information, and then the information is outputted. Thus, it is possible to change the contents of the subsequent copying restriction according to a change in picture quality and so on during recording, thereby effectively protecting the copyright of the recording information.

Further, when recording information with degraded picture quality and so on is recorded, the conversion flag indicating the contents is superimposed. Thus, the restrictive conditions of copying are changed according to the quality of recording information, so that it is possible to widely distribute recording information while adjusting interests between the creator and the user of the recording information and it is possible to widely and properly restrict the copying of the recording information, thereby effectively protect the copyright of the recording information.

Embodiment 6 described that the conversion flag is added to recording information during recording in the recorder. Additionally, a similar conversion flag may be added when the picture quality degradation is performed during demodulation in the set-top box.

### (VII) Embodiment 7

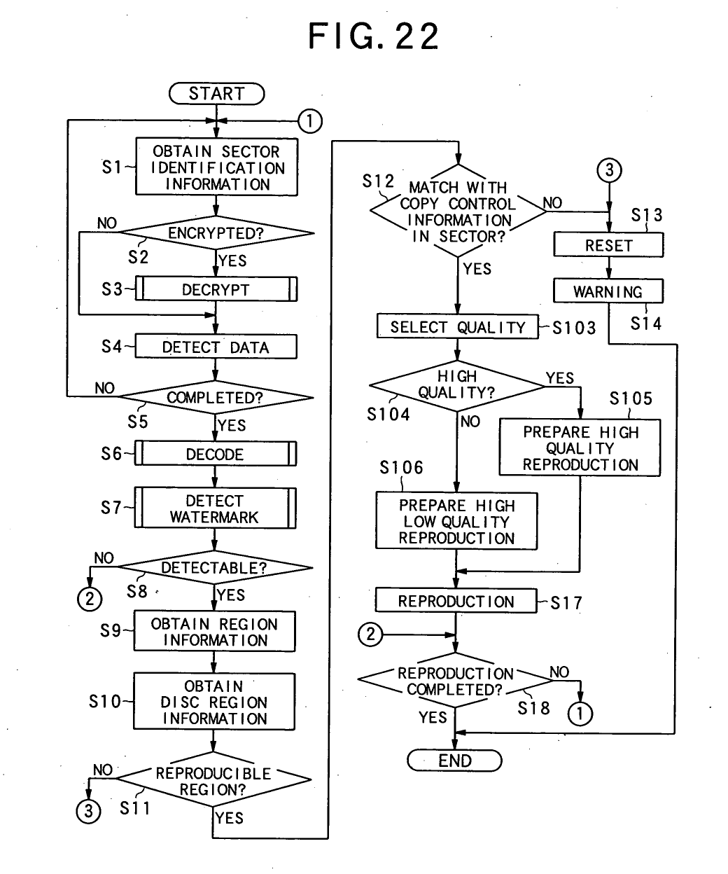

Referring to FIG. 22, the following will describe Embodiment 7 which is another embodiment of the present invention. FIG. 22 is a flowchart showing reproduction in a DVD player according to Embodiment 7. The same processing as reproduction in the DVD player P of Embodiment 2(1) shown in FIG. 6 is indicated by the same step number and the detailed explanation thereof is omitted.

The foregoing embodiments described that recording information recorded on a DVD or broadcasted recording information has only one kind of picture quality. In addition, the present invention may be applied to the case where recording information recorded on a DVD or broadcasted recording information includes two or more kinds of recording information with different picture qualities.

That is, two or more kinds of recording information are broadcasted with different picture qualities in the broadcasting stage or the stage of recording on a DVD. Alternatively, during recording, copy restriction information having the contents corresponding to the two or more kinds of recording information is set for the recording information in the broadcasting stage or the recording stage, and the recording information is broadcasted (or recorded).

Then, when airwaves are received or the DVD is reproduced, the processing of steps S1 to S14 is performed first as in the DVD player P of Embodiment 2(1).

Subsequently, when it is decided in step S12 that the contents of copy control information IF corresponding to a region indicated by region information match with the contents of region copy control information ACCI corresponding to the region (step S12; YES), the picture quality of recording information to be reproduced is selected in a set-top box for receiving broadcasting or the DVD player for reproducing recording information (step S103). When the selected picture quality is high quality among the two or more kinds of picture qualities (step S104; YES), a preparing operation is performed to detect and reproduce the high-quality recording information from the DVD (step S105). Then, reproduction is performed so that the decoded (step S6) recording information is reproduced in the prepared reproduction format and is outputted as an analog output signal Sao (step S17).

When it is decided in step S104 that the selected picture quality is not high picture quality (step S104), a preparing operation is performed to detect and reproduce low-quality recording information from the DVD (step S106). Then, reproduction is performed so that the decoded (step S6) recording information is reproduced in the prepared reproduction format and is outputted as the analog output signal Sao (step S17).

Subsequently, the processing of step S18 is performed as in Embodiment 2 (1) and the reproduction is completed.

According to Embodiment 7 described above, even when recording information recorded on the DVD or broadcasted recording information includes two or more kinds of recording information with different picture qualities, it is possible to properly protect the copyright of the recording information as in Embodiments 1 to 6.

The following configuration is also applicable: programs corresponding to the flowcharts of FIGS. 6, 12, 14, 16, 19, 20, 21, and 22 are recorded on a recording medium including a flexible disc or a hard disc, and the programs are read and executed by a microcomputer and so on, so that the microcomputer and so on are caused to act as a system control section 7 in the DVD player P, a CPU 25 in a set-top box STB, and a system control section 54 in a recorder R or RCC.

As a matter of course, the present invention is not limited to the foregoing embodiments and thus various modifications may be made within the scope of claims.

For example, in the recorder R (information recording apparatus) and the DVD player P (information reproducing apparatus) according to the foregoing embodiments, when picture quality is degraded before recording information is reproduced, copy control information included in reproduced recording information is set according to post conversion copy control information included in original recording information. Copy control information included in recording information may be set beforehand according to copy control information, which is used before picture quality degradation, and a format of the picture quality degradation. To be specific, for example, when recording information includes copy control information which has high-definition (HD) contents indicating prohibition of copy (Never Copy), the recorder R (information recording apparatus) may prohibit the recording information from being recorded on the DVD 1 with maintained high-definition quality, and the recorder R may permit the recording information to be recorded on the DVD 1 after being converted down (the quality is reduced) to standard (SD). The copy control information included in the recording information recorded on the DVD 1 may be set at, e.g., prohibition of replication and recording (No More Copy).

In the case of the DVD player P (information reproducing apparatus), when the DVD 1 is reproduced on which high-definition (HD) contents serve as recording information including copy control information indicating prohibition on copy, the copy control information included in outputted recording information may be set at “replication prohibited” during reproduction with the same quality, that is, high-definition quality. When the recording information is converted down to standard before being reproduced and outputted, the copy control information included in the outputted recording information may be set as, for example, copy control information permitting only one replication (One More Copy).

1. An information generating apparatus comprising adding device for adding change copy control information and normal copy control information to an information signal, the change copy control information being used when a changing operation for changing quality of the information signal is performed, the normal copy control information being used when the changing operation is not performed.

2. The information generating apparatus according to claim 1, wherein the changing operation is quality degradation for degrading the quality of the information signal.

3. The information generating apparatus according to claim 1, wherein the information signal includes at least image information, and the changing operation is enlargement for scaling up an image corresponding to the image information or a reduction for scaling down the image.

4. The information generating apparatus according to claim 3, wherein the changing operation is enlargement or a reduction and superimposition of another image information on the image information having been subjected to enlargement or a reduction.

5. The information generating apparatus according to claim 1, wherein the changing operation is superimposition of advertisement information on the information signal.

6. The information generating apparatus according to claim 1, wherein the changing operation is a reducing operation for reducing an amount of data of the information signal.

7. The information generating apparatus according to claim 1, wherein the change copy control information includes a restrictive condition for copying, the condition being more moderate than a restrictive condition for copying of the normal copy control information.

8. The information generating apparatus according to claim 1, wherein the adding device embeds the change copy control information and the normal copy control information in the information signal by using digital watermarking.

9. An information reproducing apparatus for reproducing an information signal, to which change copy control information and normal copy control information are added, the change copy control information being used when a changing operation for changing quality of the information signal is performed, the normal copy control information being used when the changing operation is not performed,
the apparatus comprising:
changing device for performing the changing operation, and
setting device for, when the changing operation is performed and the information signal is reproduced, setting copy control information included in the reproduced information signal at a value indicated the change copy control information.

10. (canceled)

11. The information reproducing apparatus according to claim 9, wherein when the information signal is reproduced without the changing operation, the setting device sets, as the contents of the normal copy control information, the contents of the copy control information included in the reproduced information signal.

12. An information reproducing apparatus for reproducing an information signal added with change information indicating whether a changing operation for changing quality of the information signal is performed or not, change copy control information being used when the changing operation is performed and normal copy control information being used when the changing operation is not performed,
reproducing apparatus comprising:
detecting device for detecting the change information,
deciding device for deciding whether the quality is changed or not according to the detected change information, and
setting device for setting, when the quality is changed, copy control information included in the reproduced information signal at a value indicated the change copy control information.

13. An information recording apparatus for recording an information signal, to which change copy control information and normal copy control information are added, the change copy control information being used when a changing operation for changing quality of the information signal is performed, the normal copy control information being used when the changing operation is not performed, on an information recording medium,
the recording apparatus comprising:
changing device for performing the changing operation,
selecting device for selecting a kind of the changing operation capable of recording the information signal on the recording medium, and
recording device for recording the information signal on the recording medium, the information signal having been changed in quality by the selected changing operation.

14. An information recording apparatus for recording an information signal, to which change copy control information and normal copy control information are added, the change copy control information being used when a changing operation for changing quality of the information signal is performed, the normal copy control information being used when the changing operation is not performed, on a recording medium,
the recording apparatus comprising:
changing device for performing the changing operation,
first recording device for recording the information signal changed in quality on the recording medium, and
second recording device for recording change information on the recording medium, the change information indicating that the quality of the information signal is changed.

15. An information generating method comprising:
an adding process of adding change copy control information and normal copy control information to the information signal, the change copy control information being used when a changing operation for changing quality of the information signal is performed, the normal copy control information being used when the changing operation is not performed.

16. An information reproducing method for reproducing an information signal, to which change copy control information and normal copy control information are added, the change copy control information being used when a changing operation for changing quality of the information signal is performed, the normal copy control information being used when the changing operation is not performed,
the reproducing method comprising:
a changing process of performing the changing operation, and
a setting process of, when the changing operation is performed and the information signal is reproduced, setting copy control information included in the reproduced information signal at a value indicated the change copy control information.

17. An information reproducing method for reproducing an information signal added with change information indicating whether a changing operation for changing quality of the information signal is performed or not, change copy control information being used when the changing operation is performed and normal copy control information being used when the changing operation is not performed,
the reproducing method comprising:
a detecting process of detecting the change information,
a deciding process of deciding whether the quality is changed or not according to the detected change information, and
a setting process of setting, when the quality is changed, copy control information included in the reproduced information signal at a value indicated the change copy control information.

18. An information recording method for recording an information signal, to which change copy control information and normal copy control information are added, the change copy control information being used when a changing operation for changing quality of the information signal is performed, the normal copy control information being used when the changing operation is not performed, on an information recording medium,
the recording method comprising:
a changing process of performing the changing operation,
a selecting process of selecting a kind of the changing operation capable of recording the information signal on the recording medium, and
a recording process of recording the information signal on the recording medium, the information signal having been changed in quality by the selected changing operation.

19. An information recording method for recording an information signal, to which change copy control information and normal copy control information are added, the change copy control information being used when a changing operation for changing quality of the information signal is performed, the normal copy control information being used when the changing operation is not performed, on a recording medium,
the recording method comprising:
a changing process of performing the changing operation,
a first recording process of recording the information signal changed in quality on the recording medium, and
a second recording process of recording change information on the recording medium, the change information indicating that the quality of the information signal is changed.

20. A copyright protecting method for protecting a copyright of an information signal by adding, to the information signal, copy control information for restricting copying of the information signal,
wherein the copy control information includes change copy control information being used when a changing operation for changing quality of the information signal is performed and normal copy control information being used when the changing operation is not performed.

21. An information generating program causing a generating computer included in an information generating apparatus to act as adding device for adding change copy control information and normal copy control information to an information signal, the change copy control information being used when a changing operation for changing quality of the information signal is performed, the normal copy control information being used when the changing operation is not performed.

22. An information reproducing program for a reproducing computer included in an information reproducing apparatus for reproducing an information signal, to which change copy control information and normal copy control information are added, the change copy control information being used when a changing operation for changing quality of the information signal is performed, the normal copy control information being used when the changing operation is not performed, the reproducing program causing the reproducing computer to act as:
changing device for performing the changing operation, and
setting device for, when the changing operation is performed and the information signal is reproduced, setting copy control information included in the reproduced information signal at a value indicated the change copy control information.

23. An information reproducing program for a reproducing computer included in an information reproducing apparatus for reproducing an information signal added with change information indicating whether a changing operation for changing quality of the information signal is performed or not, change copy control information being used when the changing operation is performed and normal copy control information being used when the changing operation is not performed,
the reproducing program causing the reproducing computer to act as:
detecting device for detecting the change information,
deciding device for deciding whether the quality is changed or not according to the detected change information, and
setting device for setting, when the quality is changed, copy control information included in the reproduced information signal at a value indicated the change copy control information.

24. An information recording program for a recording computer included in an information recording apparatus for recording an information signal, to which change copy control information and normal copy control information are added, the change copy control information being used when a changing operation for changing quality of the information signal is performed, the normal copy control information being used when the changing operation is not performed, on an information recording medium,
the recording program causing the recording computer to act as:
changing device for performing the changing operation,
selecting device for selecting a kind of the changing operation capable of recording the information signal on the recording medium, and
recording device for recording the information signal on the recording medium, the information signal having been changed in quality by the selected changing operation.

25. An information recording program for a recording computer included in an information recording apparatus for recording an information signal, to which change copy control information and normal copy control information are added, the change copy control information being used when a changing operation for changing quality of the information signal is performed, the normal copy control information being used when the changing operation is not performed, on a recording medium,
the recording program characterized by causing the recording computer to act as:
changing device for performing the changing operation,
first recording device for recording the information signal changed in quality on the recording medium, and
second recording device for recording change information on the recording medium, the change information indicating that the quality of the information signal is changed.

26. An information recording medium, wherein the information generating program of claim 21 is recorded so that the program is read by the generating computer.

27. An information recording medium, wherein the information reproducing program of claim 22 is recorded so that the program is read by the reproducing computer.

28. An information recording medium, wherein the information reproducing program of claim 24 is recorded so that the program is read by the recording computer.

29. A recording medium comprising an information recording area for recording an information signal added with change copy control information used when a changing operation for changing quality of the information signal is performed and normal copy control information used when the changing operation is not performed.

30. The recording medium according to claim 29, wherein the information signal further added with change information indicating whether quality of an information signal is changed or not.

31. An information recording medium, wherein the information reproducing program of claim 23 is recorded so that the program is read by the reproducing computer.

32. An information recording medium, wherein the information reproducing program of claim 25 is recorded so that the program is read by the recording computer.
